(19) United States
(12) Patent Application Publication
(10) Pub. No.: US 2025/0182616 A1
(43) Pub. Date: Jun. 5, 2025

(54) TRAFFIC FLOW MEASUREMENT SYSTEM AND TRAFFIC FLOW MEASUREMENT METHOD

(71) Applicant: Panasonic Holdings Corporation, Osaka (JP)

(72) Inventors: Kazuhiro TSUBOTA, Kanagawa (JP); Hiroyuki YUMOTO, Kanagawa (JP)

(73) Assignee: Panasonic Holdings Corporation, Osaka (JP)

(21) Appl. No.: 18/832,196

(22) PCT Filed: Jan. 6, 2023
(86) PCT No.: PCT/JP2023/000125

§ 371 Date: Feb. 7, 2025

(30) Foreign Application Priority Data
Jan. 26, 2022 (JP) 2022-010363

(51) Int. Cl. G08G 1/04; G06T 15/00; G08G 1/01

(52) U.S. Cl. CPC G08G 1/04; G06T 15/00; G08G 1/0133

(57) ABSTRACT

[Task to be accomplished]

To enable a user to easily check whether or not a sensor is set to properly detect a moving body that appears in a measurement area after adjustment of an installation state of the sensor.

[Solution]

A traffic flow measurement server places a virtual object of a moving body in a 3D space including 3D point cloud data acquired by a lidar, in response to a user's operation on a terminal device, displays a lidar point cloud image 265 including an image 271 of the virtual object of the moving body, and overlays images 277, 278 of the virtual object on a camera image 263 and a lidar intensity image 264 based on a positional relationship between the 3D point cloud data and the virtual object.

### TECHNICAL FIELD

The present disclosure relates to a traffic flow measurement system and a traffic flow measurement method for measuring a traffic flow at a target location using sensors such as cameras and lidars (LiDAR: laser imaging detection and ranging).

### BACKGROUND ART

Traffic flow measurement is used to determine a traffic situation at a target point, such as an intersection, for the purpose of improving the safety and smoothness of road traffic. In such traffic flow measurement, it is desirable to acquire detailed and highly accurate traffic flow data on conditions of vehicles, pedestrians, and other moving bodies (moving objects) without requiring much manpower.

Known technologies developed in view of the need, include acquiring the path (movement path) of a moving body in a 3D space by using sensors for detecting objects in a measurement target area, the sensors including, in addition to a camera, a lidar(s), which recently has been drawing attention in various technical fields such as self-driving (Patent Document 1). T this prior art involves a processing operation to map a captured image acquired by the camera with 3D point cloud data of an image acquired by the lidar. The prior art also involves a processing operation to integrate 3D point cloud data sets associated with a plurality of lidars installed at different points.

### PRIOR ART DOCUMENT(S)

### Patent Document(s)

Patent Document 1: JP2006-113645A

### SUMMARY OF THE INVENTION

### Task to be Accomplished by the Invention

In traffic flow measurement using sensors, it is desirable that a moving body that appears in a measurement area be continuously detected without interruption until the moving body moves out of the measurement area. Therefore, when a sensor is newly installed or when a sensor is replaced, an installation state of the sensor needs to be adjusted so that the sensor can properly detect a moving body that appears in the measurement area.

Examples of when a moving object cannot be continuously detected include a case where a moving body temporarily disappears due to an obstacle and the path of the moving object is interrupted. One prior art solution to the problem of failure of continuous detection of a moving body is using a plurality of sensors and placing each sensor at a proper location.

However, when a plurality of sensors installed at different points detect a moving body in a measurement area, the continuity of detection of the moving body cannot be maintained when two adjacent sensors temporarily fail to properly detect the same moving object. In particular, in the case of a large moving body such as a large bus or a trailer, the moving body tends to extend beyond a detection area of a sensor, which prevents proper detection of the moving object, resulting in the failure of maintaining the continuity of detection of the moving body.

Such problems can be caused by a slight deviation in an installation state (detection angle) of a sensor. Thus, there is a need for a technology that enables a user to easily check whether or not a sensor is properly set to detect a moving body that appears in a measurement area after adjustment of the installation state of the sensor. However, there has not been any technology in the prior art that meets a need of enabling easy check of sensor settings after adjustment of an installation state of a sensor.

The present disclosure has been made in view of the problem of the prior art, and a primary object of the present disclosure is to provide a traffic flow measurement system and a traffic flow measurement method which enable a user to easily check whether or not a sensor is set to properly detect a moving body that appears in a measurement area after adjustment of an installation state of the sensor.

### Means to Accomplish the Task

An aspect of the present disclosure provides a traffic flow measurement system comprising: a first sensor configured to acquire a two-dimensional detection result of a measurement area of a traffic flow: a second sensor configured to acquire a three-dimensional detection result of the measurement area; a server device connected to the first and second sensors and configured to acquire sensor images based on the detection results of the first and second sensors, and perform a traffic flow analysis operation; and a terminal device which is connected to the server device via a network and displays the sensor images and a result of the traffic flow analysis operation, wherein, in response to a user's operation on the terminal device, the server device places a virtual object of a moving body in a three-dimensional space including the three-dimensional detection result acquired by the second sensor, and wherein, based on a positional relationship between the three-dimensional detection result of the measurement area and the virtual object, the server device generates an installation check screen in which the virtual object of the moving body is overlaid on the sensor image which is the two-dimensional detection result acquired by the first sensor, and transmits the installation check screen to the terminal device.

Another aspect of the present disclosure provides a traffic flow measurement method performed by a traffic flow measurement system comprising: a first sensor configured to acquire a two-dimensional detection result of a measurement area of a traffic flow: a second sensor configured to acquire a three-dimensional detection result of the measurement area; a server device connected to the first and second sensors and configured to acquire sensor images based on the detection results of the first and second sensors, and perform a traffic flow analysis operation; and a terminal device which is connected to the server device via a network and displays the sensor images and a result of the traffic flow analysis operation, wherein the traffic flow measurement method comprises performing operations by the server device, the operations comprising: in response to a user's operation on the terminal device, placing a virtual object of a moving body in a three-dimensional space including the three-dimensional detection result acquired by the second sensor, and based on a positional relationship between the three-dimensional detection result of the measurement area and the virtual object, generating an installation check screen in which by overlaying the virtual object of the moving body is overlaid on the sensor image which is the two-dimensional detection result acquired by the first sensor, and transmitting the installation check screen to the terminal device.

### Effect of the Invention

According to the present disclosure, in response to placement of a virtual object of a moving body in a three-dimensional space including a three-dimensional detection result acquired by a second sensor, a virtual object of the moving body is overlaid on a sensor image which is a two-dimensional detection result acquired by a first sensor. As a result, a user is enabled to easily check whether or not a sensor is set to properly detect a moving body that appears in a measurement area after adjustment of an installation state of the sensor.

### BRIEF DESCRIPTION OF THE DRAWINGS

FIG. 1 is a diagram showing an overall configuration of a traffic flow measurement system according to one embodiment of the present disclosure;

FIG. 2 is a block diagram showing a schematic configuration of a traffic flow measurement server;

FIG. 3 is an explanatory diagram showing traffic flow data generated by the traffic flow measurement server;

FIG. 4 is an explanatory diagram showing transitions of screens displayed on a user terminal;

FIG. 5 is an explanatory diagram showing a main menu screen displayed on a user terminal;

FIG. 6 is an explanatory diagram showing a sub-menu screen displayed on a user terminal;

FIG. 7 is an explanatory diagram showing a sub-menu screen displayed on a user terminal;

FIG. 8 is an explanatory diagram showing a basic adjustment screen displayed on a user terminal;

FIG. 9 is an explanatory diagram showing a basic adjustment screen displayed on a user terminal;

FIG. 10 is an explanatory diagram showing a basic adjustment screen displayed on a user terminal;

FIG. 11 is an explanatory diagram showing a basic adjustment screen displayed on a user terminal;

FIG. 12 is an explanatory diagram showing an alignment screen displayed on a user terminal;

FIG. 13 is an explanatory diagram showing an alignment screen displayed on a user terminal;

FIG. 14 is an explanatory diagram showing an alignment screen displayed on a user terminal;

FIG. 15 is an explanatory diagram showing an alignment screen displayed on a user terminal;

FIG. 16 is an explanatory diagram showing an installation check screen displayed on a user terminal;

FIG. 17 is an explanatory diagram showing an installation check screen displayed on a user terminal;

FIG. 18 is an explanatory diagram showing an installation check screen displayed on a user terminal;

FIG. 19 is an explanatory diagram showing an installation check screen displayed on a user terminal;

FIG. 20 is an explanatory diagram showing another example of an installation check screen displayed on a user terminal;

FIG. 21 is an explanatory diagram showing a sensor data record screen displayed on a user terminal;

FIG. 22 is an explanatory diagram showing a sensor data analysis screen displayed on a user terminal;

FIG. 23 is an explanatory diagram showing a sensor data analysis screen displayed on a user terminal;

FIG. 24 is an explanatory diagram showing a time series indication screen displayed on a user terminal;

FIG. 25 is an explanatory diagram showing a time series indication screen displayed on a user terminal;

FIG. 26 is an explanatory diagram showing main information in a time series indication screen displayed on a user terminal;

FIG. 27 is an explanatory diagram showing a scenario designation screen displayed on a user terminal;

FIG. 28 is an explanatory diagram showing a scenario designation screen displayed on a user terminal;

FIG. 29 is an explanatory diagram showing a statistical data designation screen displayed on a user terminal;

FIG. 30 is an explanatory diagram showing a designated event viewer screen displayed on a user terminal;

FIG. 31 is an explanatory diagram showing a designated event viewer screen displayed on a user terminal;

FIG. 32 is an explanatory diagram showing a tracking mode screen displayed on a user terminal;

FIG. 33 is an explanatory diagram showing a tracking mode screen displayed on a user terminal;

FIG. 34 is an explanatory diagram showing an extended viewer mode screen displayed on a user terminal;

FIG. 35 is an explanatory diagram showing an extended viewer mode screen displayed on a user terminal:

FIG. 36 is a flowchart showing a procedure of operations for sensor installation adjustment performed by a traffic flow measurement server:

FIG. 37 is a flowchart showing a procedure of operations for traffic data generation performed by a traffic flow measurement server; and

FIG. 38 is a flowchart showing a procedure of operations for traffic data viewer performed by a traffic flow measurement server.

### DESCRIPTION OF THE PREFERRED EMBODIMENT(S)

A first aspect of the present disclosure made to achieve the above-described object is a traffic flow measurement system comprising: a first sensor configured to acquire a two-dimensional detection result of a measurement area of a traffic flow: a second sensor configured to acquire a three-dimensional detection result of the measurement area; a server device connected to the first and second sensors and configured to acquire sensor images based on the detection results of the first and second sensors, and perform a traffic flow analysis operation; and a terminal device which is connected to the server device via a network and displays the sensor images and a result of the traffic flow analysis operation, wherein, in response to a user's operation on the terminal device, the server device places a virtual object of a moving body in a three-dimensional space including the three-dimensional detection result acquired by the second sensor, and wherein, based on a positional relationship between the three-dimensional detection result of the measurement area and the virtual object, the server device generates an installation check screen in which the virtual object of the moving body is overlaid on the sensor image which is the two-dimensional detection result acquired by the first sensor, and transmits the installation check screen to the terminal device.

According to this configuration, in response to placement of a virtual object of a moving body in a three-dimensional space including a three-dimensional detection result acquired by a second sensor, a virtual object of the moving body is overlaid on a sensor image which is a two-dimensional detection result acquired by a first sensor. As a result, a user is enabled to easily check whether or not a sensor is set to properly detect a moving body that appears in a measurement area after adjustment of an installation state of the sensor.

A second aspect of the present disclosure is the traffic flow measurement system of the first aspect, wherein, based on a positional relationship between three-dimensional information on the measurement area and the virtual object, the server device generates an installation check screen in which the virtual object of the moving body is overlaid on a sensor image which is generated from the three-dimensional detection result acquired by the second sensor.

In this configuration, in response to placement of a virtual object of a moving body in a three-dimensional space including a three-dimensional detection result acquired by a second sensor, the virtual object of the moving body is overlaid on a sensor image which is generated from the three-dimensional detection result acquired by the second sensor. As a result, in addition to the checking of the first sensor, a user is enabled to easily do the checking of the second sensor after adjustment of an installation state of the sensor.

A third aspect of the present disclosure is the traffic flow measurement system of the first aspect, wherein the first sensor is a camera that acquires a captured image as the two-dimensional detection result, and the second sensor is a lidar that acquires three-dimensional point cloud data as the three-dimensional detection result.

In this configuration, a user is enabled to easily do the checking of a camera and a lidar as sensors after adjustment of an installation state of each of the sensors.

A fourth aspect of the present disclosure is the traffic flow measurement system of the first aspect, wherein, in response to the user's operation to select a type of the moving body, the server device places a virtual object of the selected type of a moving body in the three-dimensional space.

This configuration allows as user to select a type of the moving body and causes the server device to place a virtual object of the selected type of a moving body in the three-dimensional space. As a result, even when the moving body is a large moving body such as a large bus or a trailer, which is likely to extend beyond a detection area of a sensor, a user is enabled to check a state of detection by the sensor.

A fifth aspect of the present disclosure is the traffic flow measurement system of the first aspect, wherein, when the virtual object of the moving object overlaid on a sensor image includes a part that is extending off and missing from the sensor image, the server device highlights the sensor image.

This configuration enables a user to easily determine whether or not the virtual object of the moving body overlaid on the sensor image includes a part that is extending off and missing from the image, that is, the sensor is not set to properly detect the moving body that appears in the measurement area.

A sixth aspect of the present disclosure is the traffic flow measurement system of the fifth aspect, wherein a method of highlighting the sensor image is at least one of blinking, changing a color, and changing a line type of a display frame of the sensor image.

This configuration enables a user to further easily determine that the sensor is not set to properly detect the moving body that appears in the measurement area.

A seventh aspect of the present disclosure is a traffic flow measurement method performed by a traffic flow measurement system comprising: a first sensor configured to acquire a two-dimensional detection result of a measurement area of a traffic flow: a second sensor configured to acquire a three-dimensional detection result of the measurement area; a server device connected to the first and second sensors and configured to acquire sensor images based on the detection results of the first and second sensors, and perform a traffic flow analysis operation; and a terminal device which is connected to the server device via a network and displays the sensor images and a result of the traffic flow analysis operation, wherein the traffic flow measurement method comprises performing operations by the server device, the operations comprising: in response to a user's operation on the terminal device, placing a virtual object of a moving body in a three-dimensional space including the three-dimensional detection result acquired by the second sensor, and based on a positional relationship between the three-dimensional detection result of the measurement area and the virtual object, generating an installation check screen in which by overlaying the virtual object of the moving body is overlaid on the sensor image which is the two-dimensional detection result acquired by the first sensor, and transmitting the installation check screen to the terminal device.

In this configuration, a user is enabled to easily check whether or not a sensor is set to properly detect a moving body that appears in a measurement area after adjustment of an installation state of the sensor, in the same manner as the first aspect.

Embodiments of the present disclosure will be described below with reference to the drawings.

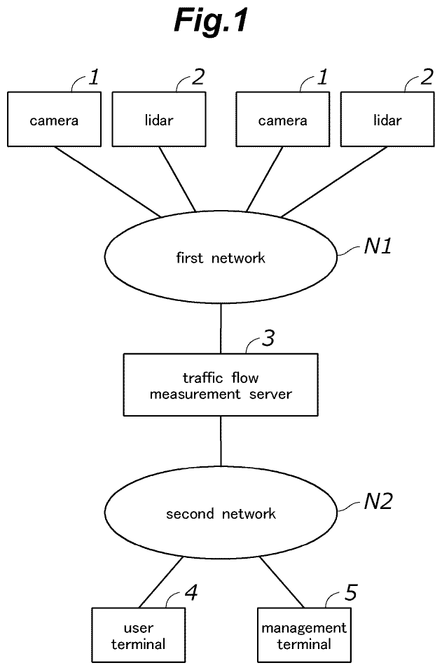

FIG. 1 is a diagram showing an overall configuration of a traffic flow measurement system according to one embodiment of the present disclosure.

The system measures traffic flow in a measurement area. The system includes a camera(s) 1 (first sensors), a lidar(s) 2 (second sensors), a traffic flow measurement server 3 (server device), a user terminal 4 (terminal device), and a management terminal 5. The camera(s) 1 and lidar(s) 2 are connected to the traffic flow measurement server 3 via a first network N1. The user terminal 4 and the management terminal are connected to the traffic flow measurement server 3 via a second network N2.

The camera(s) 1 captures the measurement area and acquires camera images as a 2D detection result(s) (two-dimension information) of the measurement area. The camera(s) 1 is equipped with a visible light image sensor and capable of acquiring color images.

The lidar(s) 2 (LiDAR) detects objects in the measurement area and acquires 3D point cloud data as a 3D detection result(s) (three-dimension information) of the measurement area. The lidar(s) 2 irradiates an object with laser light and acquires 3D information by detecting reflected light from the object. A 3D sensor other than lidars 2 may also be used.

The traffic flow measurement server 3 acquires camera images from the camera(s) 1 and 3D point cloud data acquired by the lidar(s) 2, and performs a traffic flow analysis operation for the measurement area based on the camera images and 3D point cloud data. The traffic flow measurement server 3. The traffic flow measurement server 3 also performs operations to assist a user so as to enable the user to easily carry out an adjustment of an installation state of a sensor (i.e., a camera 1 and a lidar 2) upon installation of a new sensor or replacement of the sensor.

The user terminal 4 is configured by a tablet terminal or any other suitable device. The user terminal 4 displays a screen for viewer and settings transmitted from the traffic flow measurement server 3, which allows a user to adjust the installation state of a sensor and view results of the traffic flow analysis operation.

The management terminal is configured by a PC or any other suitable device. The management terminal displays a management screen transmitted from the traffic flow measurement server 3, allowing an administrator to perform management tasks such as setting conditions for processing operations performed by the traffic flow measurement server 3.

The camera(s) 1 and the lidar(s) 2 each have a function to receive satellite signals from a satellite positioning system (e.g., GPS) and update the time information in the camera(s) 1 and the lidar(s) 2 with time information contained in the satellite signals. Each sensor (a camera 1 or a lidar 2) transmits the time synchronized with a satellite signal as a detection time to the traffic flow measurement server 3 by adding the time to a detection result (camera image. 3D point cloud data). The traffic flow measurement server 3 synchronizes the detection result of each sensor (a camera 1 or a lidar 2) based on the detection time. When the camera(s) 1 and lidar(s) 2 do not have the function to receive satellite signals, time synchronization may be performed via the first network.

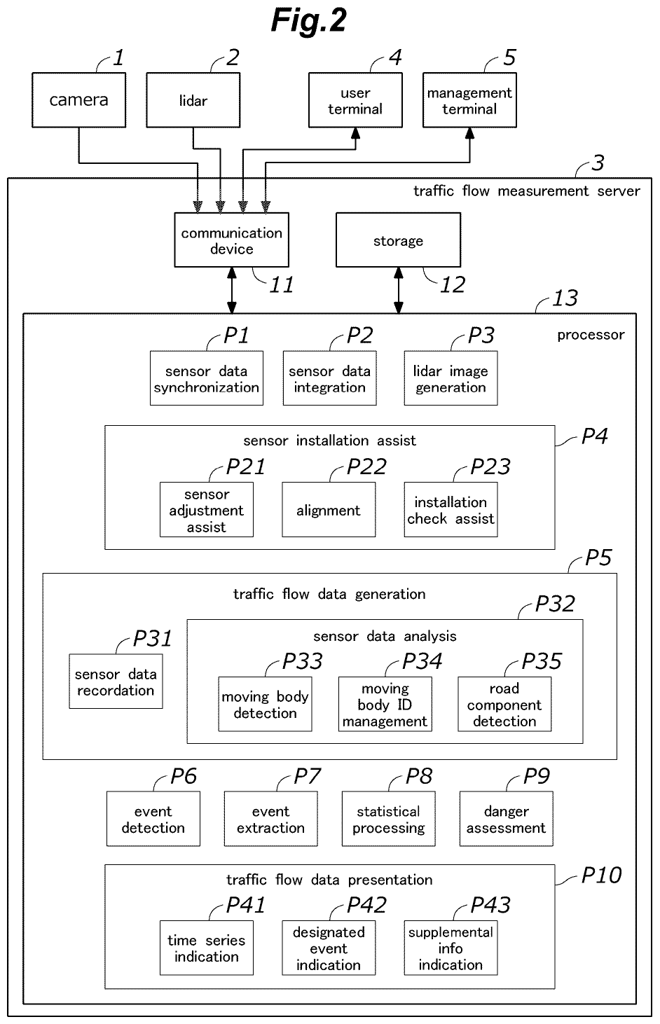

Next, a schematic configuration of the traffic flow measurement server 3 will be described. FIG. 2 is a block diagram showing a schematic configuration of the traffic flow measurement server 3.

The traffic flow measurement server 3 includes a communication device 11, a storage 12, and a processor 13.

The communication device 11 communicates with the camera(s) 1 and the lidar(s) 2 via the first network. The communication device 11 also communicates with the user terminal 4 and the management terminal via the second network.

The storage 12 stores programs that are executable by the processor 13 and other data. In addition, the storage 12 stores camera images acquired from camera(s) 1 and 3D point cloud data acquired from lidar(s) 2. The storage 12 also stores traffic flow data generated by the processor 13. The storage 12 also stores CG images (simulation images) of the measurement points. The storage 12 also stores sensor installation information acquired in each of the operations of basic adjustment, alignment, and installation confirmation. The sensor installation information includes information on detection angles of sensors (cameras 1 and lidars 2), information on the positional relationship between camera images and each set of 3D point cloud data, and information on the mutual positional relationship between sets of in 3D point cloud data sets acquired by a plurality of lidars 2.

The processor 13 performs various operations by executing programs stored in a memory. In the present embodiment, the processor 13 performs a sensor data synchronization operation P1, a sensor data integration operation P2, a lidar image generation operation P3, a sensor installation assist operation P4, a traffic flow data generation operation P5, an event detection operation P6, an event extraction operation P7, a statistical processing operation P8, a danger assessment operation P9, a traffic flow data presentation operation P10, and other operations.

In the sensor data synchronization operation P1, the processor 13 maps each of the camera images acquired from the camera(s) 1 to the 3D point cloud data acquired from a corresponding one of the lidar(s) 2 based on the detection time. In the present embodiment, the camera(s) 1 adds the time included in a received satellite signal to a camera image as a detection time and transmits the detection time to the traffic flow measurement server 3. The lidar(s) 2 adds the time included in a received satellite signal to 3D point cloud data as a detection time and transmits the detection time to the traffic flow measurement server 3.

In the sensor data integration operation P2, the processor 13 integrates (synthesizes) a plurality of 3D point cloud data sets provided from the plurality of lidars 2 at different locations into one data set.

In the lidar image generation operation P3, the processor 13 generates a lidar intensity image with a viewpoint from the sensor installation point based on the 3D point cloud data acquired by the lidar(s) 2. The processor 13 also generates a lidar point cloud image with a user-designated viewpoint based on the 3D point cloud data. In the present embodiment, the 3D point cloud data is displayed as a lidar point cloud image using a 3D viewer on the user terminal 4. A user can change the viewpoint or angle from which the image is to be created, for example, by dragging the cursor up, down, left or right on the displayed lidar point cloud image.

In the sensor installation assist operation P4, the processor 13 performs operations to assist a user's operations for adjustment when a sensor (camera 1 and lidar 2) is installed in response to the user's operation on the user terminal 4. The sensor installation assist operation P4 performed at the time of sensor installation includes a sensor adjustment assist operation P21, an alignment operation P22, and an installation check assist operation P23.

In the sensor adjustment assist operation P21, the processor 13 performs operations to assist a user's operations for adjustment of the installation state of a sensor (camera 1 and lidar 2). Specifically, the processor 13 displays camera images and lidar intensity images generated from 3D point cloud data, on a user terminal 4. The imaging angles (detection angle) of the sensors (cameras 1 and lidars 2) are controlled according to the user's operations for adjustment.

In the alignment operation P22, the processor 13 estimates the relative locations of the installation points of the sensors (cameras 1 and lidars 2) with regard to each other, and maps the coordinates as a detection result for each of the sensors. Specifically, the processor maps the coordinates on the camera image to the coordinates in the 3D point cloud data. In addition, the processor 13 corrects the misalignment of a plurality of sets of 3D point cloud data acquired by the plurality of lidars 2 installed at different points.

In the installation check assist operation P23, the processor 13 places a virtual object of a moving body in a 3D space including the 3D point cloud data acquired by the lidars 2 according to the user's operation on the user terminal 4, and overlays the virtual object of the moving body on the camera images and the lidar intensity images based on the positional relationships. Then, the processor 13 determines whether or not the virtual object of the moving body overlaid on the camera images and the lidar intensity images include part that is missing from the images. i.e., whether or not the virtual object of the moving body extends off the camera image and the lidar intensity image.

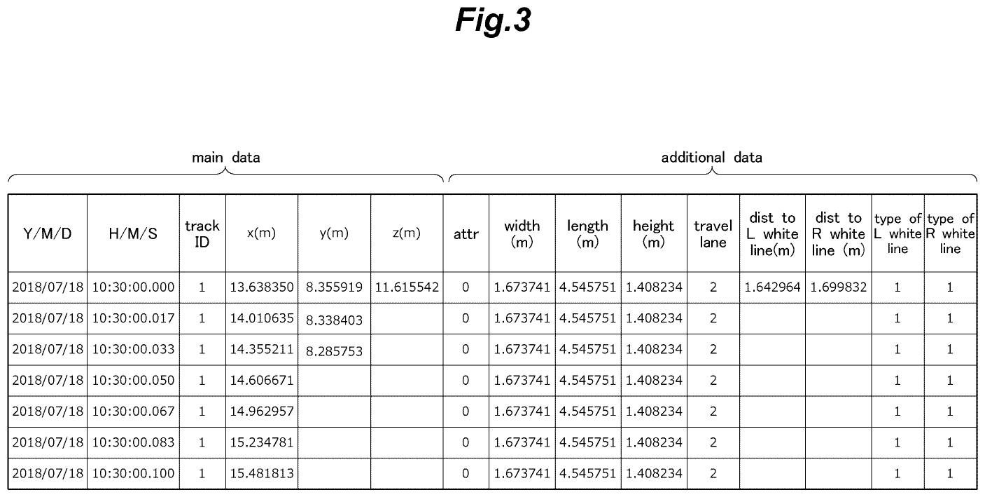

In the traffic flow data generation operation P5, the processor 13 generates traffic flow data (see FIG. 3) which represents the traffic situation in the measurement area based on sensor data (camera images. 3D point cloud data). The traffic flow data generation operation P5 includes a sensor data recordation operation P31 and a sensor data analysis operation P32 (traffic flow analysis operation).

In the sensor data recordation operation P31, the processor 13 stores camera images acquired from the cameras 1 and 3D point cloud data sets acquired from the lidars 2 in the storage 12, in response to user's instructions entered on the user terminal 4.

In the sensor data analysis operation P32 (traffic flow analysis operation), the processor 13 generates traffic flow data based on sensor data (camera images, 3D point cloud data sets) collected in the sensor data recordation operation P31. The sensor data analysis operation P32 includes a moving body detection operation P33, a moving body ID management operation P34, and a road component detection operation P35.

In the moving body detection operation P33, the processor 13 identifiably detects moving bodies (moving objects) from the camera images from the cameras 1. Specifically, the processor 13 detects buses, trucks, trailers, passenger cars, motorcycles, bicycles, and pedestrians, for example. The processor 13 also detects moving bodies from the 3D point cloud data generated by integrating a plurality of sets of 3D point cloud data acquired by the plurality of lidars 2. The processor 13 also acquires location information indicating a location of a detected moving body and assigns a moving body ID to the detected moving body. In the moving body detection operation P33, an image recognition engine (machine learning model) constructed by using machine learning technology such as deep learning may be used.

In the moving body ID management operation P34, the processor 13 controls assignment (replacement) of a moving body ID to a moving body, such that a moving body ID assigned to a moving body detected in each camera image is the same as that detected in 3D point cloud data. In the present embodiment, a user may designate a sensor(s) to be prioritized in the reassignment of the moving body ID. In this case, when detecting a moving body in data from a “non-prioritized” sensor, the processor 13 replaces its moving body ID with a moving body ID assigned to the same moving body detected in data from a “prioritized” sensor.

In the road component detection operation P35, the processor 13 identifiably detects road components from 3D point cloud data. Specifically, the processor 13 detects road components. i.e., sidewalks, curbs, guardrails, and other landmarks, as well as white lines, stop lines, and other road surface markings, through segmentation (dividing a region into a plurality of sub-regions). In the road component detection operation P35, an image recognition engine (machine learning model) constructed by using machine learning technology such as deep learning may be used.

In the event detection operation P6, the processor 13 detects an event that corresponds to a predetermined scenario(s) (event type) based on the traffic flow data that is a result of the sensor data analysis operation P32 (traffic flow analysis operation). Specifically, the processor 13 detects an event that corresponds to a scenario such as rear-end collision, right-turn collision, left-turn entrapment, reverse driving, and tailgating based on the path of each moving body. The processor 13 accumulates the results of the event detection operation in an event database.

In the event extraction operation P7, the processor 13 extracts an event that corresponds to the scenario designated by a user from stored events in the event database. In the present embodiment, the user can directly specify a scenario at the user terminal 4. The user terminal 4 can also present statistical information to a user, and the user can designate scenarios in the statistical information.

In the statistical processing operation P8, the processor 13 performs statistical processing operations based on the traffic flow data to thereby generate statistical information. For example, the processor 13 generates statistical information on the frequency of occurrence of an event that corresponds to each of a plurality of scenarios.

In the danger assessment operation P9, the processor 13 acquires information on a traffic environment at a target location based on the traffic flow data, specifically, the positional relationships between a moving body and road components, to determine a level of danger associated with the traffic environment at the target location. In the danger assessment operation P9, the processor 13 creates beforehand an index to evaluate the level of danger associated with a traffic environment at each location based on the statistical information acquired in the statistical processing operations for each location. The processor 13 determines the level of danger based on conditions of a moving body at a target location based on the danger assessment index.

In the traffic flow data presentation operation P10, the processor 13 presents traffic flow data to the user by displaying various screens on user terminal 4. The traffic flow data presentation operation P10 includes a time series indication operation P41, a designated event indication operation P42, and a supplemental information indication operation P43.

In the time series indication operation P41, the processor 13, based on the traffic flow data, visualizes and displays object behavior information indicating a behavior (a change in the state) of a moving body (state information) using graphics and characters, on the screen. In the present embodiment, the processor 13 displays the object behavior information overlaid on sensor images (camera images, lidar point cloud image, and lidar intensity images), where object behavior information includes object behavior images (path image, velocity image, and acceleration image) that visualize time-series data of the changes of the position, velocity, and acceleration of a moving body.

In the designated event indication operation P42, the processor 13 displays sensor images (such as camera images, and lidar point cloud image) associated with an event corresponding to the conditions designated by a user through the user terminal 4. In the present embodiment, a user can designate a scenario (event type) as an extraction condition, and the processor 13 displays sensor images associated with an event corresponding to the scenario designated by the user on the user terminal 4.

In the supplemental information indication operation 43, the processor 13 displays supplemental information on the screen simultaneously with a moving body, wherein the supplemental information is information associated with the traffic environment of a measurement area such as states of road components (e.g., white lines and sidewalks), and types of moving bodies (e.g., passengers, motor vehicles, trucks). Specifically, the processor 13 highlights the objects designated by the user on the sensor images (camera images, lidar point cloud image, and lidar intensity images) in an identifiable manner.

Next, traffic flow data generated by the traffic flow measurement server 3 will be described. FIG. 3 is an explanatory diagram showing traffic flow data.

The traffic flow measurement server 3 generates traffic flow data (tracking data) for each moving body (path ID). The table in FIG. 3 includes sets of unit data generated in a time series, one row for unit data each time indicated by timestamp. In the example shown in FIG. 3, the table includes data relating to a moving body with a tracking ID of “1. The target moving body of a vehicle (passenger car) with an attribute number of “0.” The vehicle is traveling in the x direction.

Traffic flow data includes a time stamp (year, month, day, hour, minute, second), a path ID, coordinates (x, y, z) (of a relative position), an attribute, vehicle size data (width, length, height), travel lane, distances to the white line (left white line, right white line), and types of white line. The main data includes the timestamp, the path ID, and the relative coordinates (position information), and the other data is additional data.

The path ID is assigned to the movement path of the moving body and is used to identify the moving body. The relative coordinates (x, y, z) represent the position of the moving body at each time. The attribute represents the type of a moving body, e.g., 0 for passenger vehicles. 1 for large vehicles. 2 for motorcycles, and 3 for unknown objects. The travel lanes are represented by the numbers 1 and 2, from left to right. The types of white line are represented by the numbers. For example, a solid line is 0 and a dashed line is 1.

The traffic flow data may further include: absolute coordinates (latitude, longitude, sea level altitude); a direction of travel (angle) of the moving body: a road alignment (road curvature, road longitudinal slope, road transverse slope); road coordinates (Lx, Ly, dLx, dLy); velocity: acceleration (traveling direction, lateral direction); road width; number of lanes: road type (1: intercity expressway, urban expressway, national highway, 2: mainline, merge, branch, ramp); type of lane marker (left side of vehicle, right side of vehicle): collision margin time with a vehicle in front: attributes of vehicle in front (passenger vehicle, large vehicle, motorcycle, unknown); and relative speeds and travel lanes of nearby vehicles. In addition, the traffic flow data may include information about the tracking frame of the moving body acquired by using image recognition.

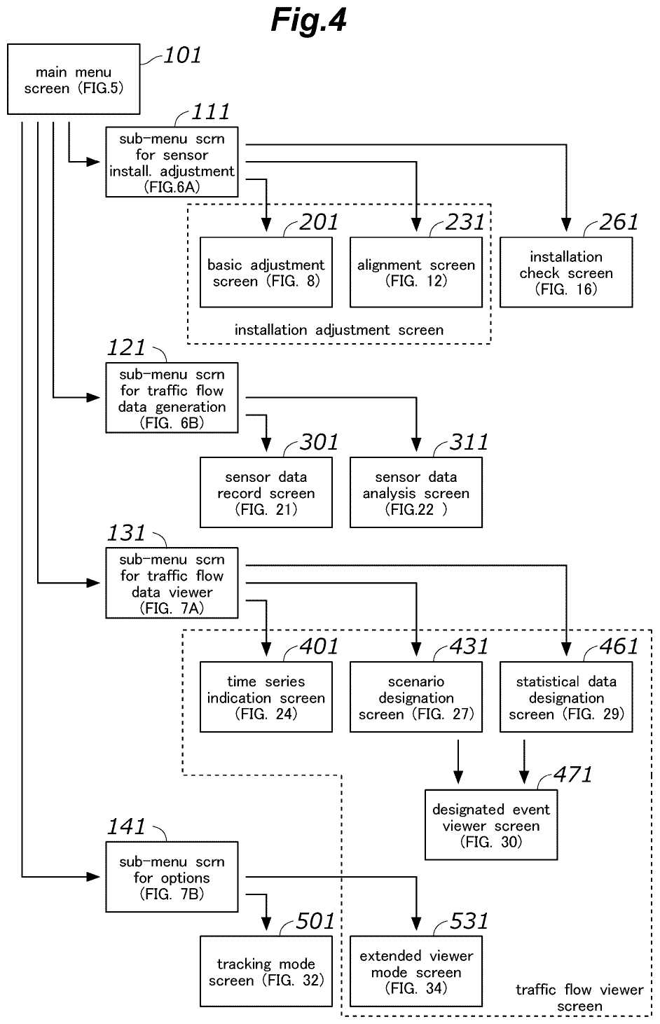

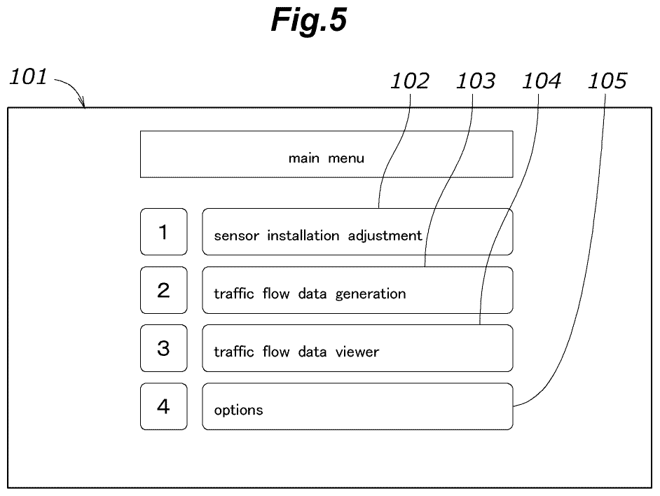

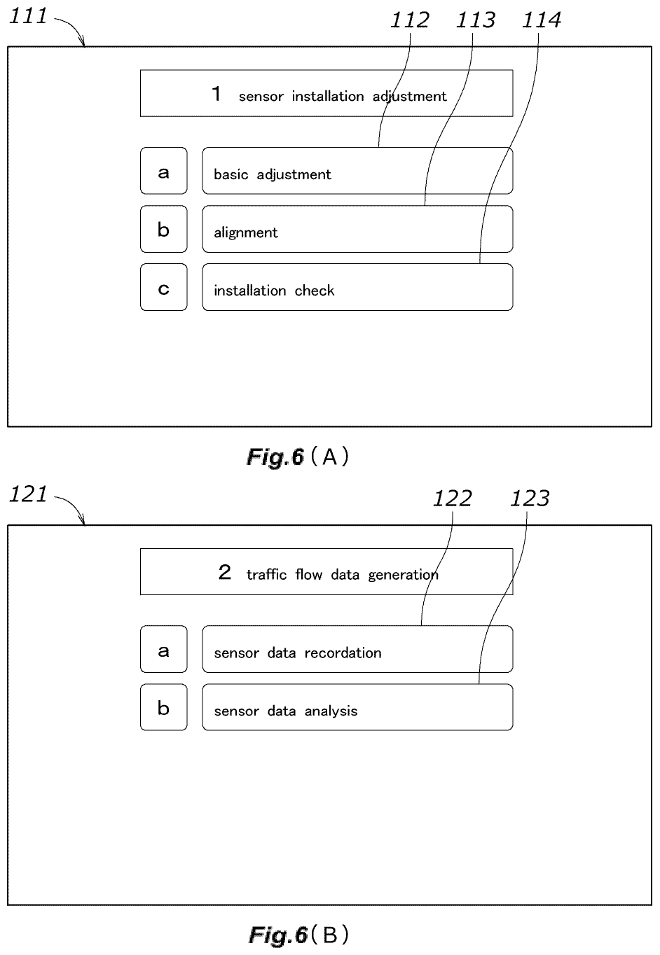

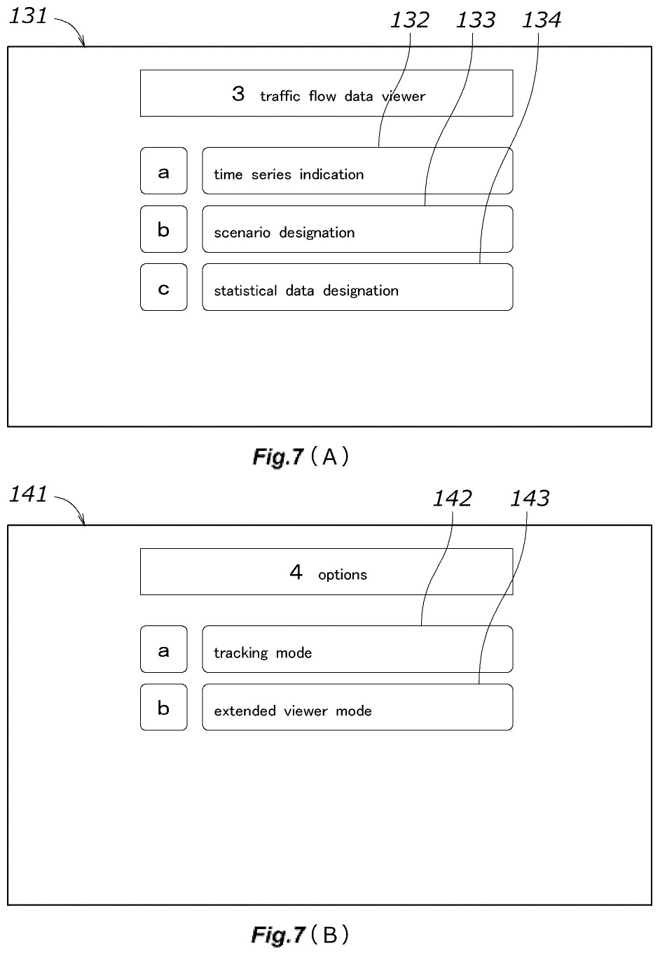

Next, screens displayed on a user terminal 4 will be described below. FIG. 4 is an explanatory diagram showing transitions of screens displayed on a user terminal. FIG. 5 is an explanatory diagram showing a main menu screen displayed on a user terminal. FIGS. 6 and 7 are explanatory diagrams showing sub-menu screens displayed on a user terminal.

In FIG. 5, the main menu screen 101 includes a button 102 for sensor installation adjustment, a button 103 for traffic flow data generation, a button 104 for traffic flow data viewer, and a button 105 for options. When a user operates the button 102 for sensor installation adjustment, the screen transitions to a sub-menu screen for sensor installation adjustment shown in FIG. 6(A). When a user operates the button 103 for traffic flow data generation, the screen transitions to the sub-menu screen for traffic flow data generation shown in FIG. 6(B). When a user presses the button 104 for traffic flow data viewer, the screen transitions to a sub-menu screen for traffic flow data viewer shown in FIG. 7(A). When a user operates the button 105 for options, the screen transitions to the sub-menu screen for options shown in FIG. 7(B).

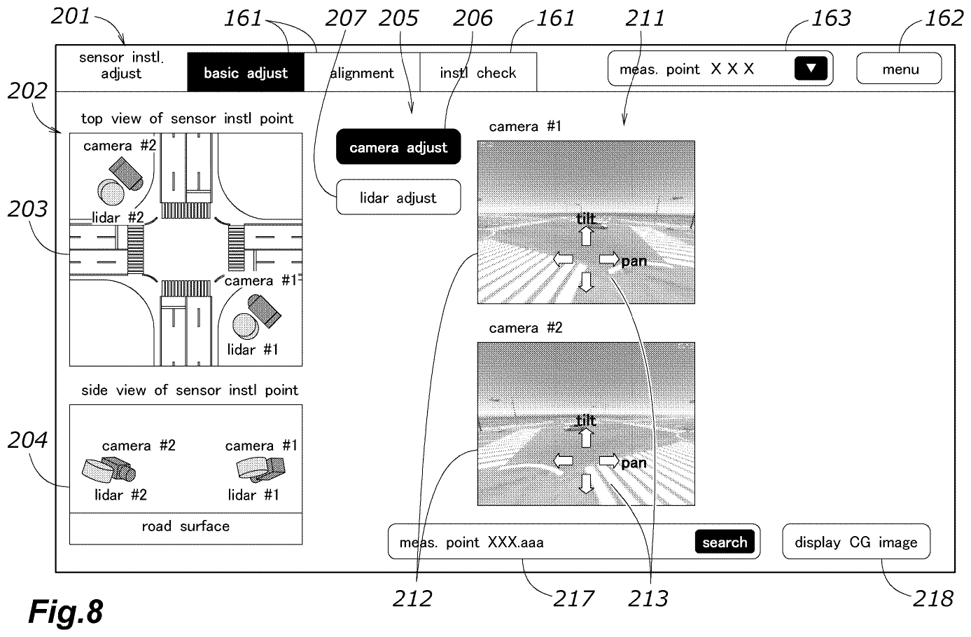

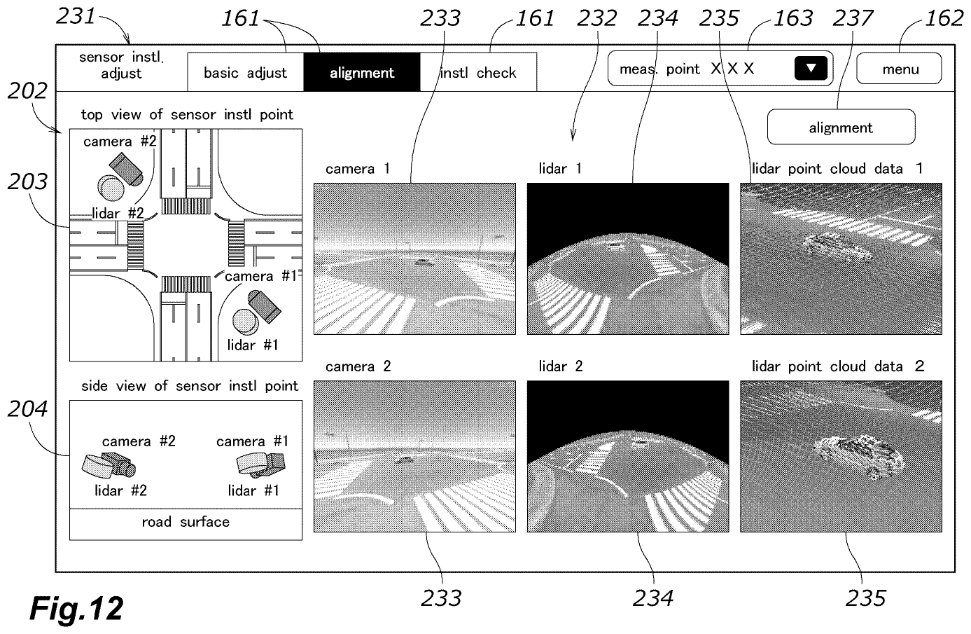

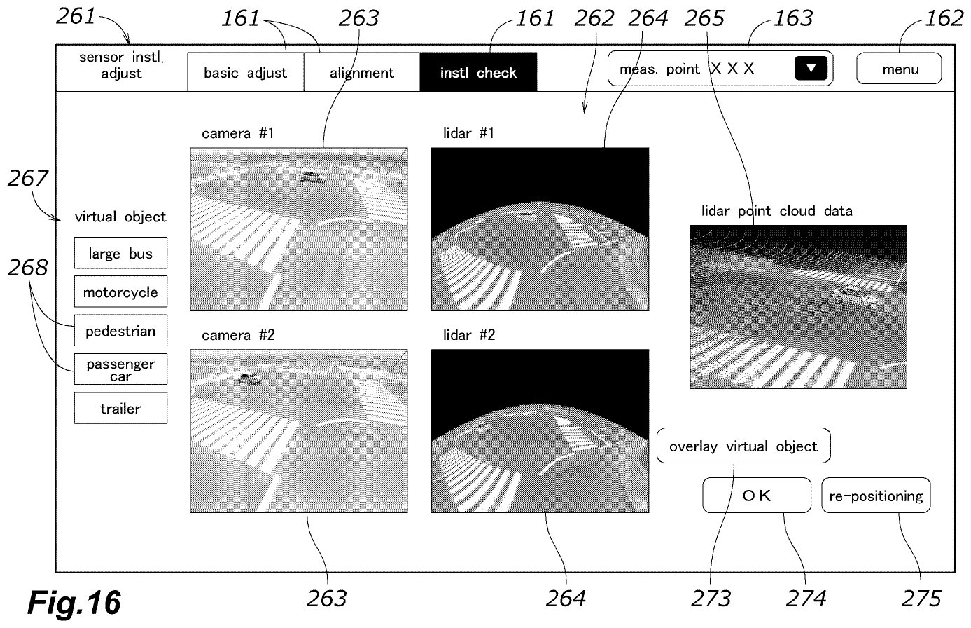

In FIG. 6(A), a sub-menu screen 111 for sensor installation adjustment includes a button 112 for basic adjustment, a button 113 for alignment, and a button 114 for installation check. When a user operates the button 112 for basic adjustment, the screen transitions to a basic adjustment screen 201 (FIG. 8). When a user operates the button 113 for alignment, the screen transitions to an alignment screen 231 (FIG. 12). When a user operates the button 114 for installation check, the screen transitions to an installation check screen 261 (FIG. 16).

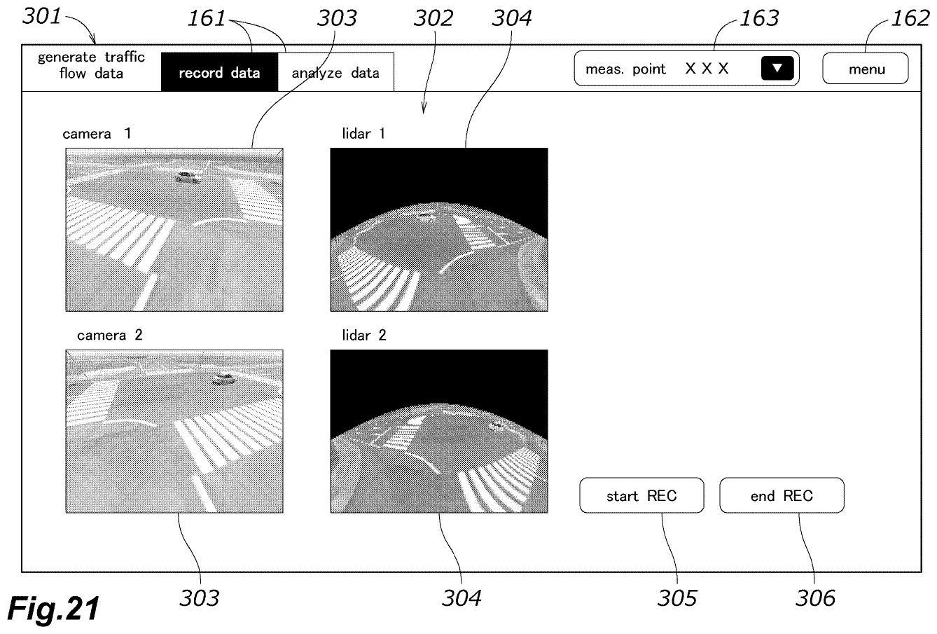

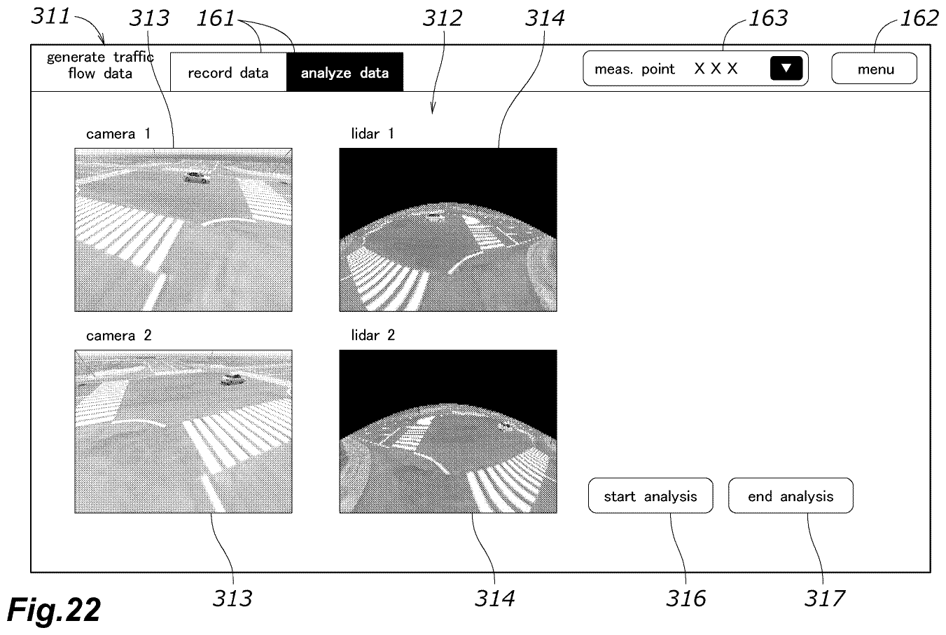

In FIG. 6(B), a sub-menu screen 121 for traffic flow data generation includes a button 122 for sensor data recordation and a button 123 for sensor data analysis. When a user operates the button 122 for sensor data recordation, the screen transitions to the sensor data record screen 301 (FIG. 21). When a user operates the button 123 for sensor data analysis, the screen transitions to a sensor data analysis screen 311 (FIG. 22).

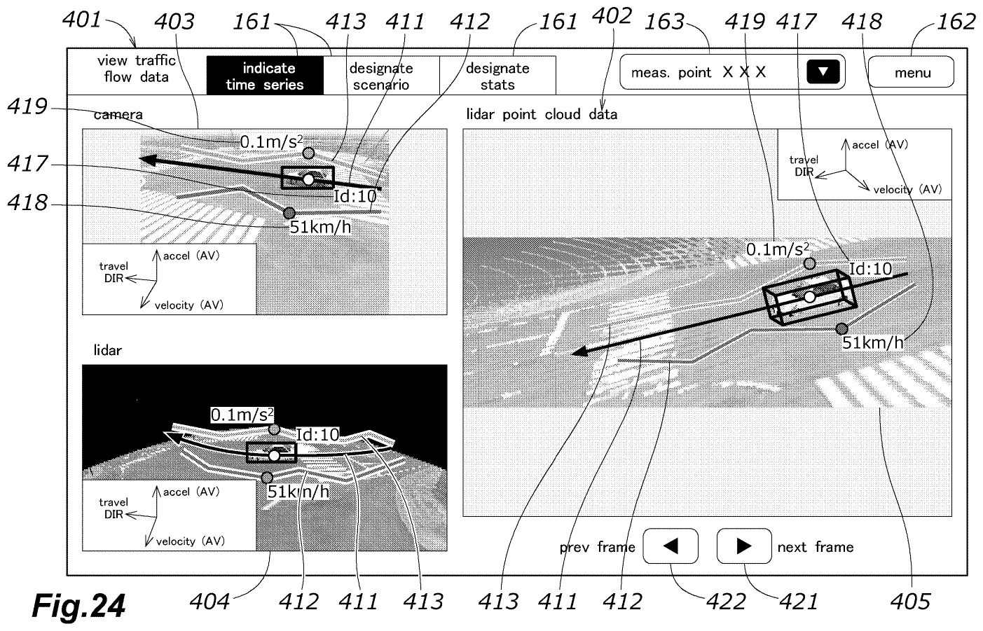

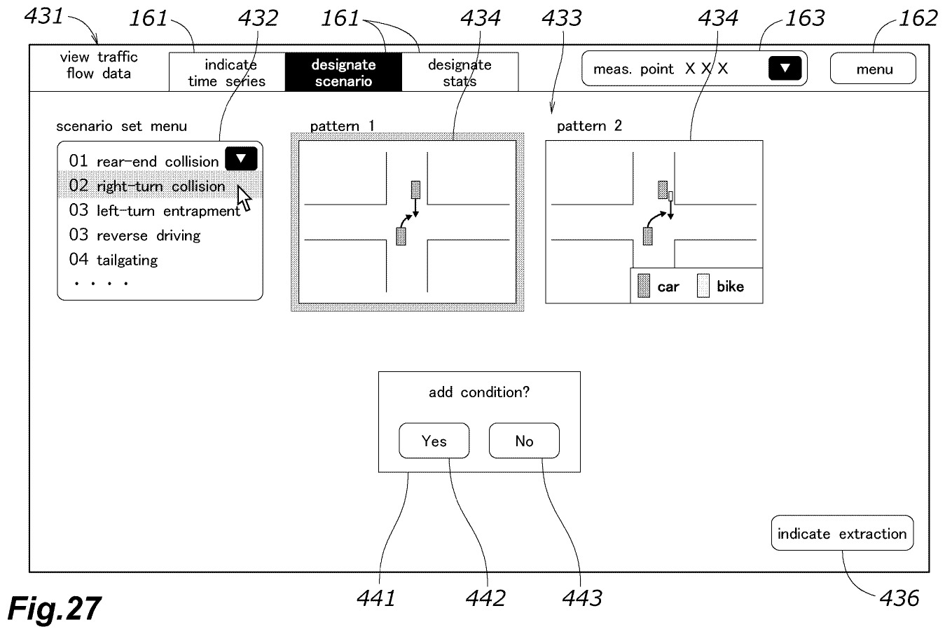

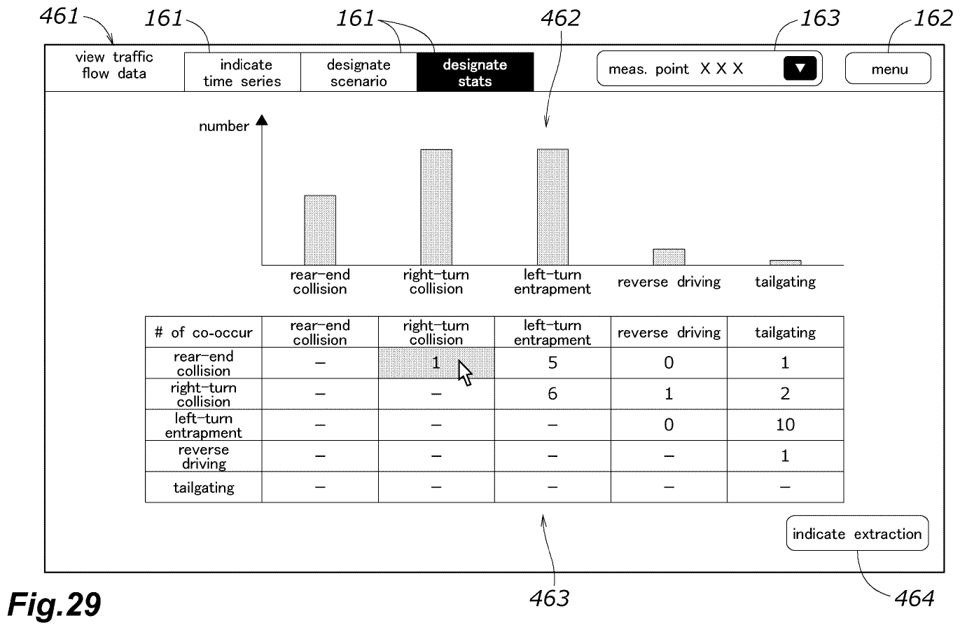

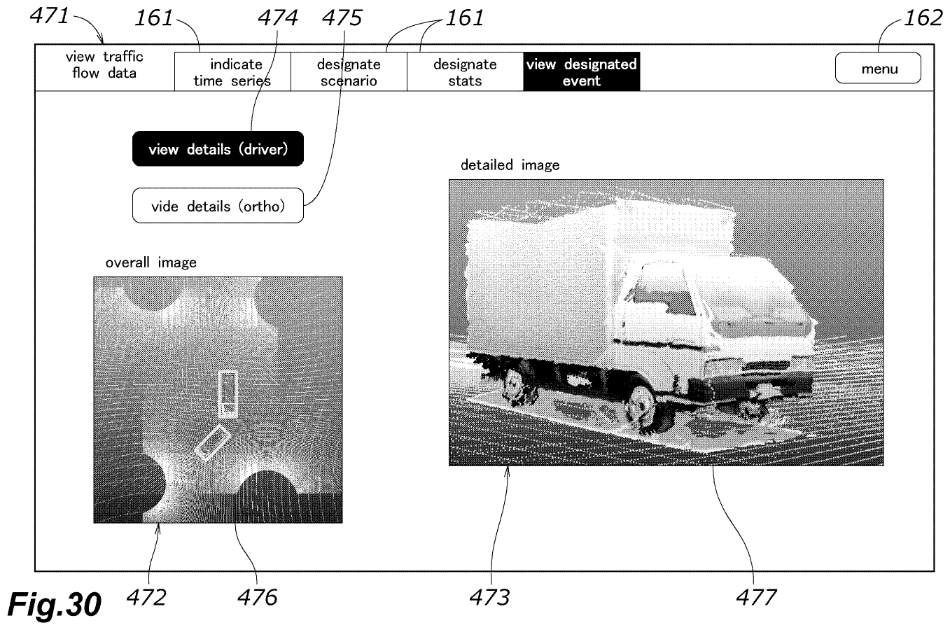

In FIG. 7(A), a sub-menu screen for traffic flow data viewer 131 includes a button for time series indication, a button for scenario designation, and a button for statistical data designation. When a user operates the button for time series indication, the screen transitions to a time series indication screen 401 (FIG. 24). When a user operates the button for scenario designation, the screen transitions to the scenario designation screen 431 (FIG. 27). When a user operates the button for designating statistical information, the screen transitions to a statistical data designation screen 461 (FIG. 29). When a user performs a predetermined operation on the scenario designation screen 431 or the statistical data designation screen 461, the screen transitions to a designated event viewer screen 471 (FIG. 30).

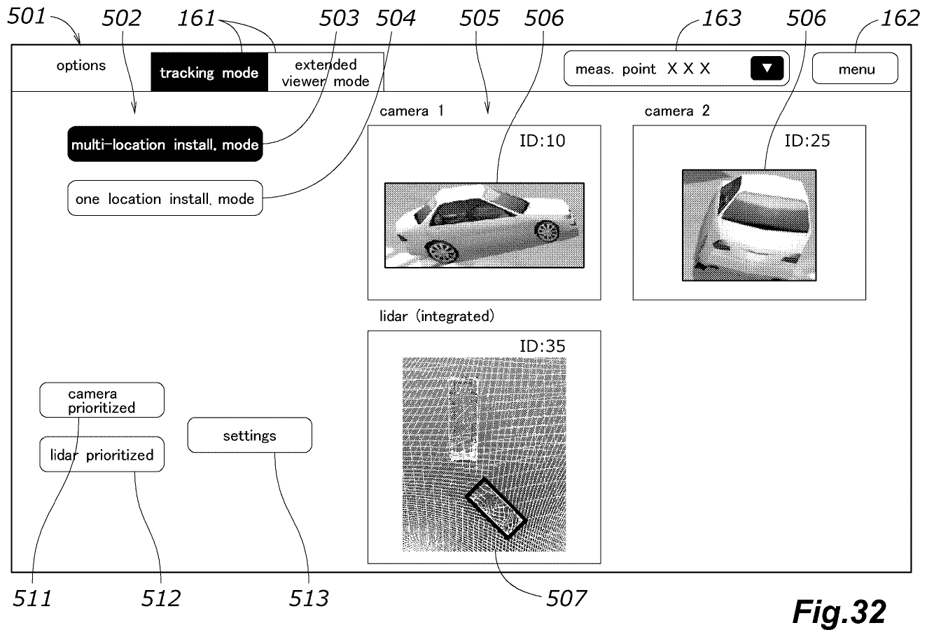

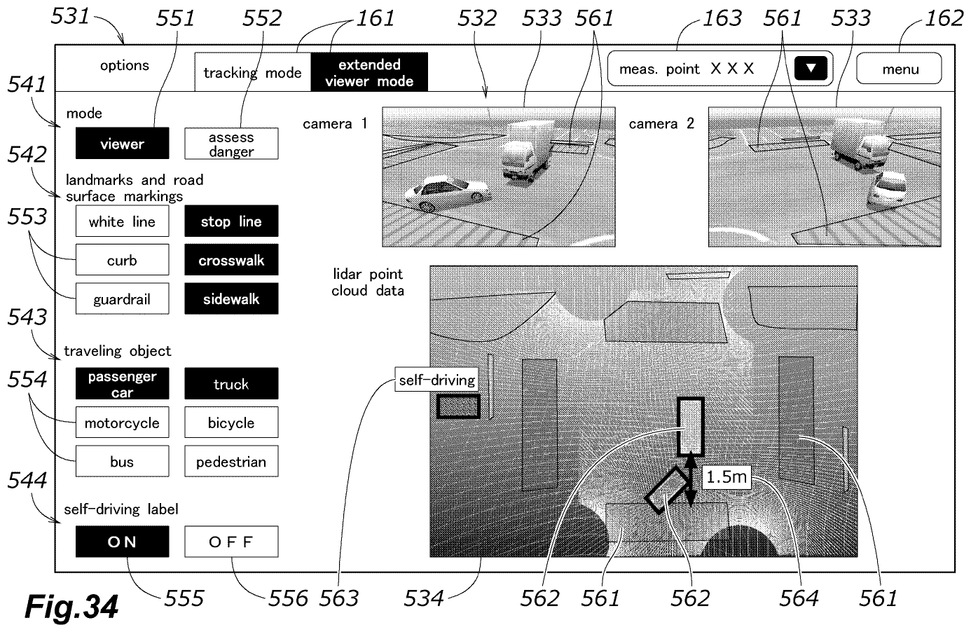

In FIG. 7(B), a sub-menu screen 141 for options includes a button 142 for tracking mode and a button 143 for extended viewer mode. When a user operates the tracking mode button 142, the screen transitions to a tracking mode screen 501 (FIG. 32). When a user operates the button 143 for extended viewer mode, the screen transitions to an extended viewer mode screen 531 (FIG. 34).

As shown in FIG. 4, the basic adjustment screen 201 (FIG. 8) and the alignment screen 231 (FIG. 12) may be referred to as installation adjustment screens. The time series indication screen 401 (FIG. 24), the scenario designation screen 431 (FIG. 27), the statistical data designation screen 461 (FIG. 29), the designated event viewer screen 471 (FIG. 30), and the extended viewer mode screen 531 (FIG. 34) may be referred to as traffic flow viewer screens.

Each of the sub-menu screens 111, 121, 131, and 141 (FIGS. 6 and 7) includes tabs 161, which correspond to respective sub-menu items (such as basic adjustment, alignment, and installation check) and a menu button 162. When a user operates each tab 161 in any of the sub-menu screens, the sub-menu screen transitions to a screen for a corresponding item of the sub-menu. When a user operates the button 162 in the menu, the screen returns to the main menu screen 101 (FIG. 5).

Each screen transitioned from a corresponding one of the sub-menu screens 111, 121, 131, and 141 (FIGS. 6 and 7) includes a measurement point designation section 163, as shown in FIG. 8. A user can select a measurement point by operating the pull-down menu in the measurement point designation section 163.

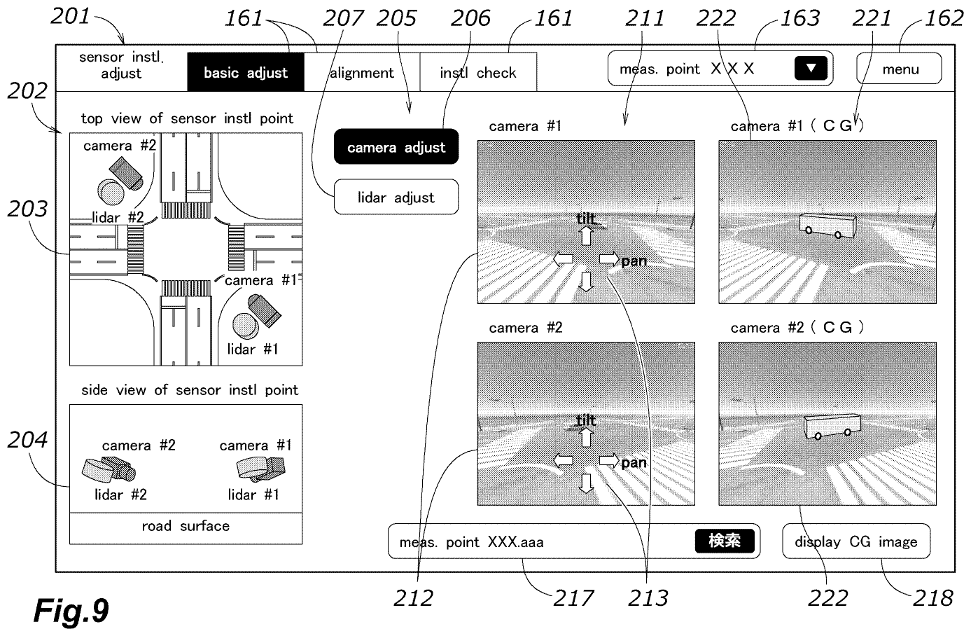

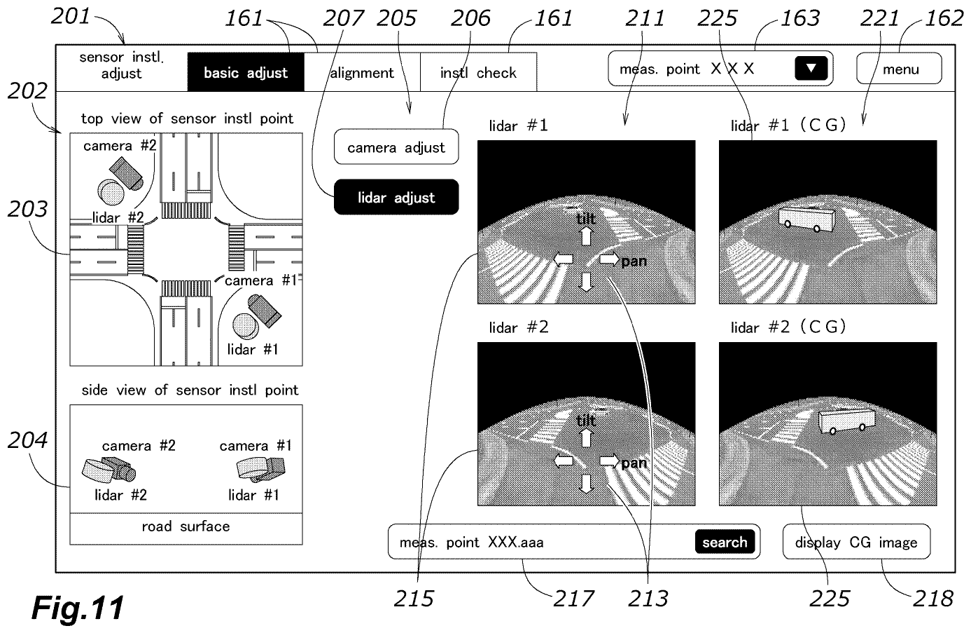

Next, the basic adjustment screen 201 displayed on a user terminal 4 will be described. FIG. 8 is an explanatory diagram showing the basic adjustment screen 201 when a CG image is not shown during adjustment of cameras. FIG. 9 is an explanatory diagram showing the basic adjustment screen 201 when a CG image is shown during adjustment of cameras. Figure is an explanatory diagram showing the basic adjustment screen 201 when a CG image is not shown during adjustment of lidars. FIG. 11 is an explanatory diagram showing the basic adjustment screen 201 when a CG image is not shown during adjustment of lidars.

When a user operates the button 102 on the main menu screen 101 displayed on the user terminal 4 (FIG. 5), the screen transitions to the sub-menu screen 111 (FIG. 6(A)), and then, when the user operates the button 112 for basic adjustment on the sub-menu screen 111, the screen transitions to the basic adjustment screen 201, as shown in FIG. 8.

The basic adjustment screen 201 shown in FIG. 8 is used when any CG image is not displayed (initial state) during camera adjustment. The basic adjustment screen 201 includes an installation plan indication section 202. The installation plan indication section 202 displays a top view 203 and a side view 204 which show the installation states of the sensors (camera(s) 1 and lidar(s) 2) at the respective sensor installation points. While carrying out the basic adjustment, a user can visually check the installation states of camera(s) 1 and lidar(s) 2 by viewing the top view 203 and the side view 204.

The top view 203 depicts camera(s) 1 and lidar(s) 2 installed around the measurement area, as viewed from the above. The side view 204 depicts camera(s) 1 and lidar(s) 2 installed around the measurement area, as viewed from a side. In this configuration, the sensors comprising #1 camera 1 and #1 lidar 2 and #2 camera 1 and #2 lidars 2 are installed so that the sensors face each other across an intersection.

When each of the cameras 1 and the lidars 2 is equipped with an IMU (Inertial Measurement Unit), the traffic flow measurement server 3 can acquire actual detection directions of the lidar(s) 2 based on IMU output information. This configuration allows the traffic flow measurement server 3 to show the top view 203 and the side view 204 so that the orientations (detection directions) of the camera(s) 1 and lidar(s) 2 in the screen change in conjunction with the change in the actual detection directions of the cameras 1 and the lidars 2. When each of the cameras 1 and the lidars 2 is equipped with no IMU, the traffic flow measurement server 3 does not acquire the actual detection directions of the cameras 1 and the lidars. In this case, the orientations of the cameras 1 and lidars 2 shown in the top view 203 and the side view 204 can be different from the actual detection directions.

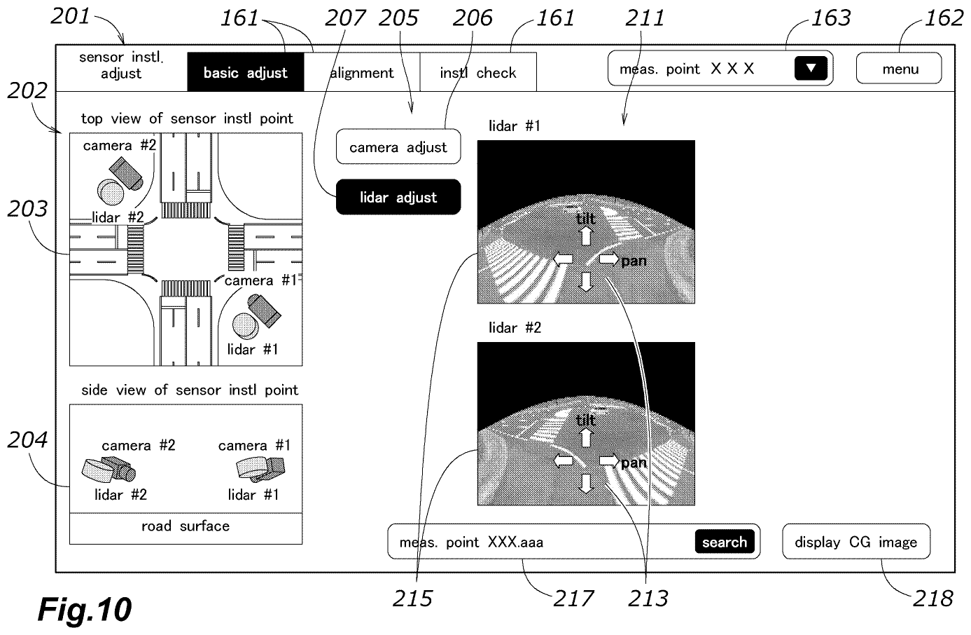

The basic adjustment screen 201 includes a sensor switch section 205. The sensor switch section 205 includes a camera adjust button 206 and a lidar adjust button 207. When a user operates the camera adjust button 206, the system starts to operate in a camera adjustment mode and the screen transitions to the basic adjustment screen 201 for camera adjustment shown in FIG. 8. When a user operates the lidar adjust button 207, the system starts to operate in a lidar adjustment mode and the screen transitions to the basic adjustment screen 201 for lidar adjustment shown in FIG. 10.

During camera adjustment, the basic adjustment screen 201 shown in FIG. 8 includes a sensor image indication section 211. The sensor image indication section 211 displays camera images 212 as sensor images (sensor detection images). In the present embodiment, since two cameras 1 are installed, the sensor image indication section displays two camera images 212 captured by the cameras 1.

In the sensor image indication section 211, a sensor angle manipulation section 213 is overlaid on each of the camera images 212. The sensor angle manipulation section 213 can be used to change the imaging angle (shooting angle) of the corresponding camera 1 (a sensor) to the designated direction: that is, to pan and tilt (in horizontal and vertical directions) the camera. This feature allows a user to adjust the angle of each of the cameras 1 while visually viewing a corresponding camera image 212.

The basic adjustment screen 201 shown in FIG. 8 includes a CG image designation section 217 and a CG image indicate button 218. A user can enter the name of a measurement point in the CG image designation section 217, and conduct a search. As a result, a CG image file containing CG images of the measurement point is acquired for camera adjustment, and a file name of the CG image file is displayed in the CG image designation section 217. Next, when the user operates the CG image indicate button 218, the screen transitions to the basic adjustment screen 201 shown in FIG. 9.

The basic adjustment screen 201 shown in FIG. 9 is used when CG images are displayed during camera adjustment. The basic adjustment screen 201 includes a CG image indication section 221. The CG image indication section 221 displays CG images 222 corresponding to the camera images 212 (sensor images) displayed in the CG image indication section 221. In this configuration, the two cameras 1 are installed, and thus the CG image indication section 221 displays two CG images 222 corresponding to the camera images 212 captured by the two cameras 1.

A CG image 222 (simulation image) is a CG reproduction of a camera image of a measurement area captured by a camera 1 adjusted to an appropriate angle. A CG image 222 is reproduced beforehand using CG technology. A CG image 222 serves as a guide for adjustment of the angle (shooting angle) of a camera 1.

Visually comparing a camera image 212 (actual image captured by a camera 1) with a corresponding CG image 222 both displayed in the sensor image indication section 211, a user can adjust the shooting angle such that the two images are generally matched with each other. In this way, the user can adjust the direction of the cameras 1 to an optimal angle.

The basic adjustment screen 201 shown in FIG. 10 is used when CG images are not displayed during lidar adjustment. The basic adjustment screen 201 includes a CG image indication section 221, which displays lidar intensity images 215 (sensor images). In the present embodiment, since two lidars 2 are installed, the sensor image indication section displays two lidar intensity images 215 detected by the lidars 2. A lidar intensity image 215 is an image, in which reflection intensity in a 3D point cloud data set acquired by a lidar 2 is expressed in terms of brightness.

During lidar adjustment, the basic adjustment screen 201 shown in FIG. 10 includes the sensor image indication section 211, in which a sensor angle manipulation section 213 is overlaid on each of the lidar intensity images 215. The sensor angle manipulation section 213 can be used to change the detection angle (detection direction) of the corresponding lidar 2 (a sensor) to the designated direction: that is, to pan and tilt (in horizontal and vertical directions) the lidar. This feature allows a user to adjust the angle of each of the lidars 2 while visually viewing a corresponding lidar intensity image 215.

As in the basic adjustment screen 201 shown in FIG. 9, the basic adjustment screen 201 shown in FIG. 10 includes the CG image designation section 217. A user can enter the name of a measurement point in the CG image designation section 217, and conduct a search. As a result, a CG image file containing CG images of the measurement point is acquired for lidar adjustment. Next, when the user operates the CG image indicate button 218, the screen transitions to the basic adjustment screen 201 in which CG images are displayed for lidar adjustment, as shown in FIG. 11.

The basic adjustment screen 201 shown in FIG. 11 is used when CG images are displayed during lidar adjustment. The basic adjustment screen 201 includes the CG image indication section 221. The CG image indication section 221 displays CG images 225 corresponding to the lidar intensity images 215 displayed in the CG image indication section 221. In this configuration, the two lidars 2 are installed, and thus the CG image indication section 221 displays two CG images 225 corresponding to the lidar intensity images 215 captured by the two lidars 2.

A CG image 225 (simulation image) is a CG reproduction of a lidar intensity image of a measurement area captured by a lidar 2 adjusted to an appropriate angle. A CG image 225 is reproduced beforehand using CG technology. A CG image 225 serves as a guide for adjustment of the angle (detection angle) of a lidar 2.

Visually comparing a lidar intensity image 215 (actual image of data acquired by a lidar 2) with a corresponding CG image 225 both displayed in the sensor image indication section 211, a user can adjust the detection angle such that the two images are generally matched with each other. In this way, the user can adjust the direction of the lidar 2 to an optimal angle.

In this way, visually viewing the camera images 212 in the basic adjustment screen 201, a user can adjust the angle (direction) of the sensors (camera(s) 1 and lidar(s) 2). Moreover, a user can adjust the sensor angles by referring to the CG images 222 and 225, which are CG reproductions of the sensor images of the measurement area detected by the sensors adjusted to appropriate angles. This enables a user to easily carry out the adjustment of an installation state of a sensor during installation of a new sensor or replacement of a sensor. In the present embodiment, the sensor switch section 205 is used to switch between the camera adjustment mode and the lidar adjustment mode. However, in other cases, the switch may be made between the camera adjustment mode and the lidar adjustment mode based on a user's operation to select a sensor(s) (camera or lidar) displayed in the top view 203 or side view 204 of the installation plan indication section 202.

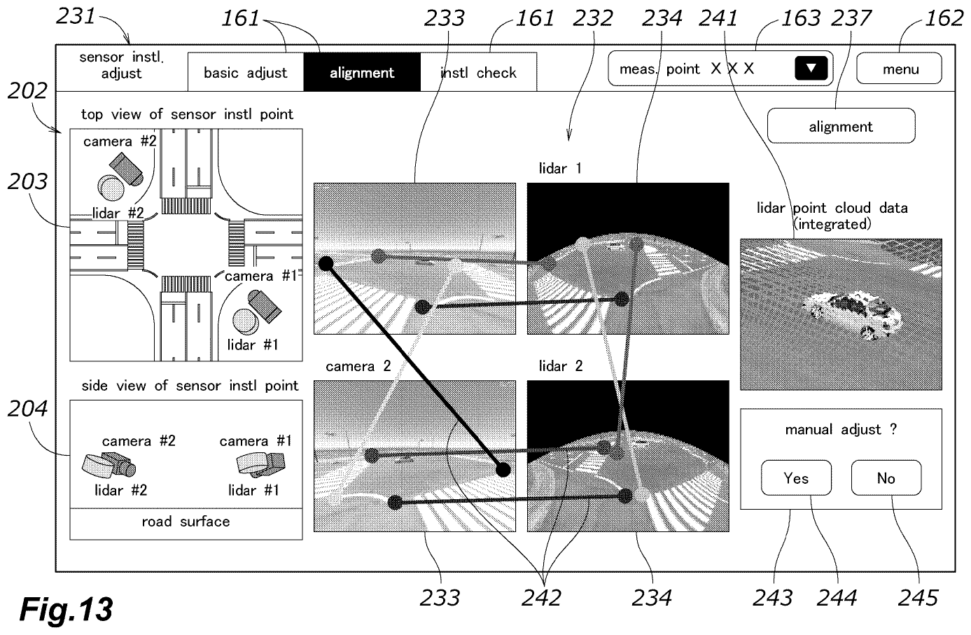

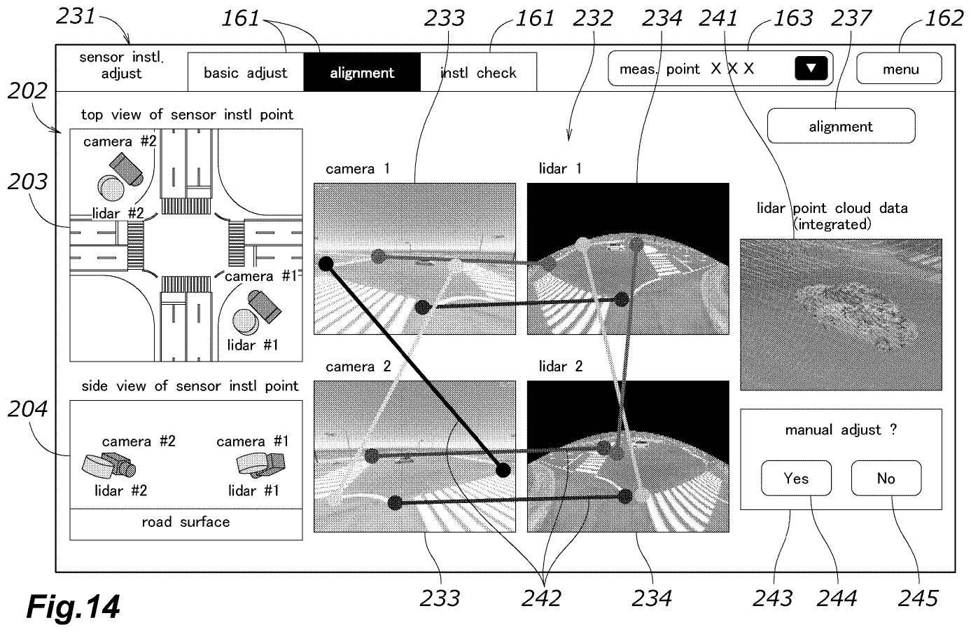

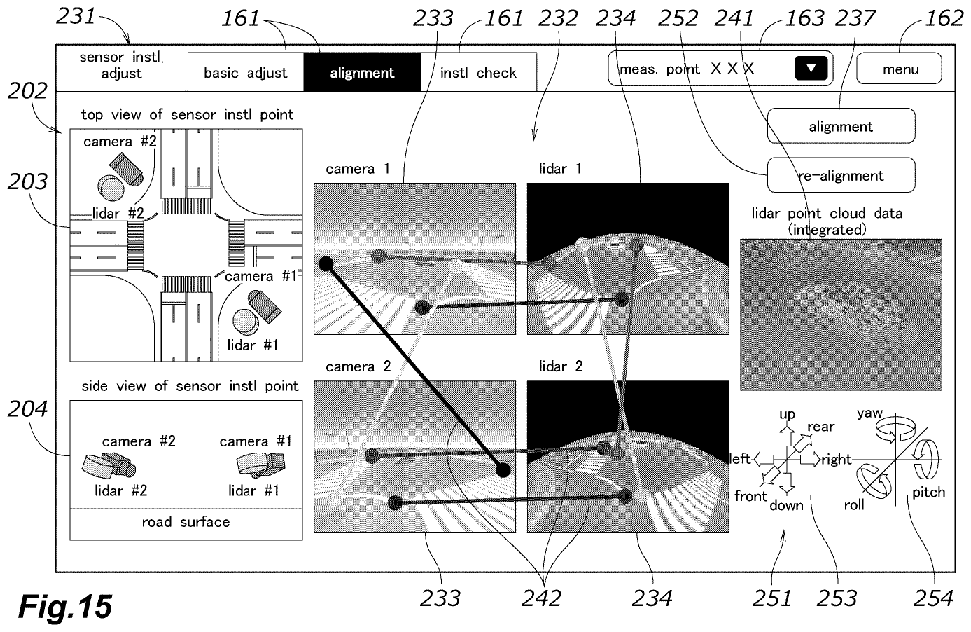

Next, an alignment screen 231 displayed on a user terminal 4 will be described. FIG. 12 is an explanatory diagram showing the alignment screen 231 in an initial state. FIG. 13 is an explanatory diagram showing the alignment screen 231 when alignment succeeds. FIG. 14 is an explanatory diagram showing the alignment screen 231 when alignment fails. FIG. 15 is an illustration showing the alignment screen 231 for manual alignment.

When a user terminal 4 shows the main menu screen 101 (FIG. 5) and the user operates the button 113 for alignment in the sub-menu screen 111 (FIG. 6(A)), the screen transitions to the alignment screen 231 shown in FIG. 12.

The alignment screen 231 shown in FIG. 12 includes the installation plan indication section 202 as in the basic adjustment screen 201 (FIG. 8). The installation plan indication section 202 displays a top view 203 and a side view 204 which show the installation states of the sensors (camera(s) 1 and lidar(s) 2).

The alignment screen 231 includes a sensor image indication section 232. The user can designate target measurement points in the measurement point designation section 163. When the designation is made, the sensor image indication section 232 displays camera images 233, lidar intensity images 234, and a lidar point cloud image 235 for the designated measurement point. The displayed images may be real-time images or stored images.

The alignment screen 231 includes a button 237 for alignment. When a user operates the alignment button 237, the process proceeds to a step of automatic alignment, and the traffic flow measurement server 3 performs the alignment operation, and, upon completion of alignment as shown in FIG. 13, the screen transitions to the alignment screen 231.

In the alignment operation, the processor 13 of the traffic flow measurement server 3 estimates the correspondences between the 3D point cloud data sets from the two camera(s) 1 and two lidar(s) 2 cameras installed at the two locations. The processor integrates the 3D point cloud data provided from the two lidars 2 based on the result of estimation. In the integration process, the relative positional relationships between points in a first set of 3D point cloud data and those in the other second set of 3D point cloud data are corrected as necessary. Specifically, the correction is made by moving or rotating the second set with regard to the first set.

As shown in FIG. 13, the alignment screen 231 is shown upon the completion of alignment, which includes the integrated lidar point cloud image 241 in the sensor image indication section 232.

The alignment screen 231, which is shown upon the completion of alignment, also displays lines which connect sets of two corresponding points in the sensor images (two camera images 233 and two lidar intensity images 234). This feature allows a user to check the correspondences between points included in the respective sensor images.

Then, viewing the integrated lidar point cloud image 241, the user can visually check whether the alignment is sufficiently made. When the alignment is not sufficiently made, an integrated lidar point cloud image 241 includes anomalies such as a double image of the moving body appearing in the integrated lidar point cloud image 241, as shown in FIG. 14.

The alignment screen 231, which is shown upon the completion of alignment, includes a manual alignment confirmation section 243 as shown in FIG. 14. The manual alignment confirmation section 243 includes a yes button 244 and a no button 245. When problems or failures are found in the integrated lidar point cloud image 241, the user can operate on the Yes button 244. As a result, the screen transitions to the alignment screen 231 for manual alignment shown in FIG. 15.

The alignment screen 231 for manual alignment shown in FIG. 15 includes a manual alignment control 251 and a button 252 for re-alignment.

The manual alignment control 251 is configured to be user-operable to correct the relative positioning of the sets of 3D point cloud data acquired by the two lidars 2. The manual alignment control 251 has a translation control 253 and a rotation control 254. A user can operate the translation control 253 to translate one of the sets of 3D point cloud data provided from the two lidars 2 to the other in a designated direction (up, down, left, right, forward, backward). The user can operate the rotation control 254 to rotate one of the two sets of 3D point cloud data in a designated direction (roll, pitch, yaw). Preferably, these controls allow a user to cause the translation or rotation by selecting one of the two lidar intensity images 234.

Then, the user can visually check the integrated lidar point cloud image 241 and performs necessary operations with the manual alignment control 251. An area of each lidar point cloud image 241 has the function of a 3D viewer, and by operating the image area to move the viewpoint from which the image is created, the user can display the lidar point cloud image 241 from any viewpoint. This configuration allows the user to check whether the relative misalignment of the two sets of 3D point cloud data provided from the two lidars has been sufficiently improved by manual positioning operations.

When the user confirms that the relative misalignment of the sets of 3D point cloud data acquired by the two lidars 2 has been sufficiently improved, the user operates the button 252 for re-alignment, causing the traffic flow measurement server 3 to re-execute the alignment operation and the screen transitions to the alignment screen 231 shown upon completion of alignment as in FIG. 13.

Since the alignment screen 231 shows the result of the integration of the two sets of 3D point cloud data acquired by the two lidars 2 installed at the two points after correcting the misalignment of the two 3D point cloud data, a user can easily confirm that the 3D point cloud data has been properly aligned. In addition, when the misalignment of two 3D point cloud data is too large and the alignment has not been made automatically, the misalignment of two 3D point cloud data can be improved manually by the user's operation. Thus, the alignment operation can be performed again to properly complete the alignment of the sets of 3D point cloud data.

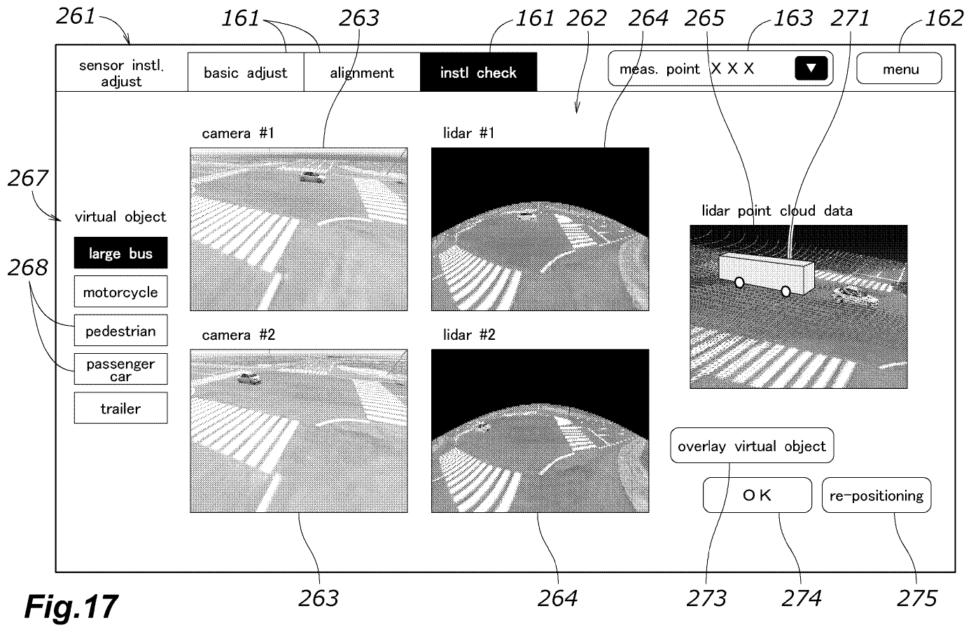

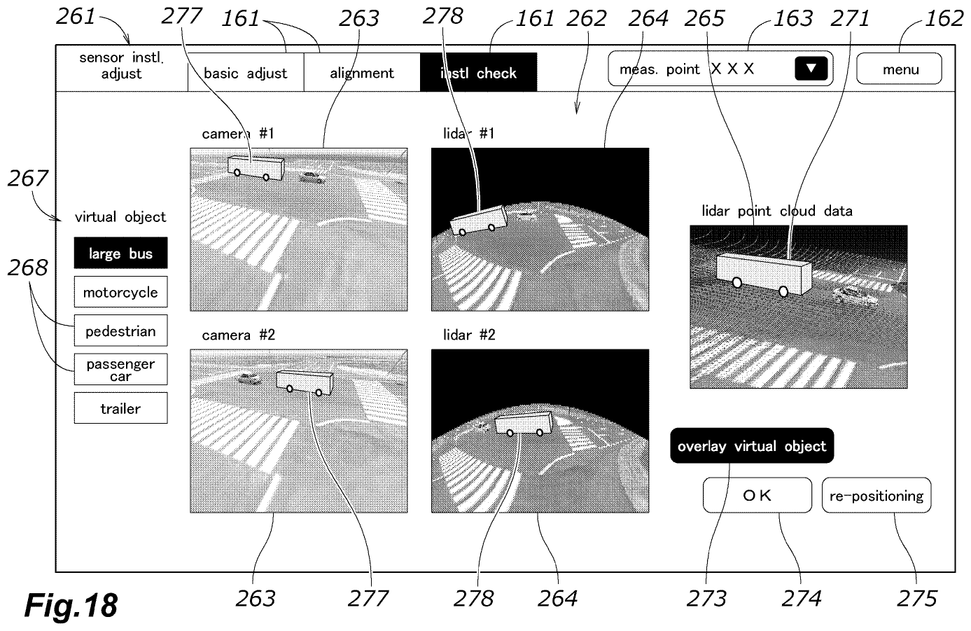

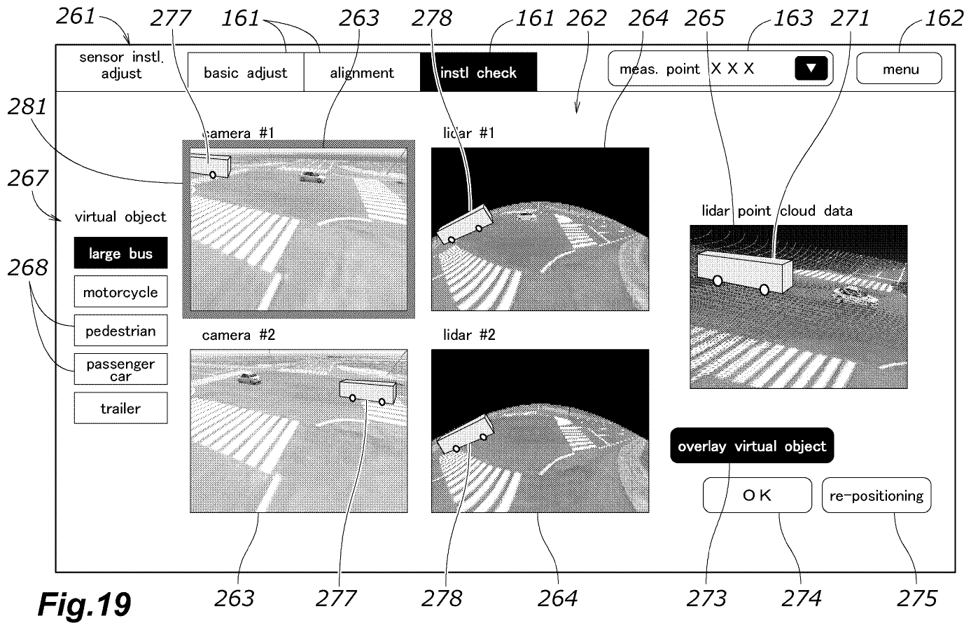

Next, an installation check screen 261 displayed on a user terminal 4 will be described. FIG. 16 is an explanatory diagram showing the installation check screen 261 in an initial state. FIG. 17 is an explanatory diagram showing the installation check screen 261 for virtual object selection. FIG. 18 is an explanatory diagram showing the installation check screen 261 when a virtual object is overlaid on the screen. FIG. 19 is an explanatory diagram showing the installation check screen 261 in an error state when a virtual object is overlaid on the screen.

When a user operates the button 102 on the main menu screen 101 displayed on the user terminal 4 (FIG. 5), the screen transitions to the sub-menu screen 111 (FIG. 6(A)), and then, when the user operates the button 114 for installation check on the sub-menu screen 111, the screen transitions to the installation check screen 261, as shown in FIG. 16.

The installation check screen 261 shown in FIG. 16 includes a sensor image indication section 262. The sensor image indication section 262 displays camera images 263, lidar intensity images 264, and a lidar point cloud image 265.

The installation check screen 261 shown in FIG. 16 shows an example in which sensors (cameras 1 and lidars 2) are installed at two points across an intersection. In this case, the installation check screen 261 displays the camera images 263 and the lidar intensity images 264 are acquired from the two cameras 1 and the two lidars 2, respectively, both installed at the two points, and a point cloud image 265 where two sets of 3D point cloud data acquired by the two lidars 2 are integrated into the 3D lidar point cloud image 265 based on the sets of 3D point cloud data acquired by the two lidars 2.

The installation check screen 261 also includes a virtual object designation section 267. The virtual object designation section 267 has buttons 268 for designating a large bus, a motorcycle, a pedestrian, a passenger car, and a trailer as virtual objects of the moving body, respectively.

As shown in FIG. 17, when a user operates one of the buttons 268 to designate a virtual object of the moving body, an image 271 of the designated virtual object of the moving body appears on the lidar point cloud image 265. In this process, the traffic flow measurement server 3 performs operations of placing the designated moving body virtual object in a 3D space containing the 3D point cloud data, and generates lidar point cloud image 265 of the 3D space including the virtual object of the moving body as well as the points of the 3D point cloud data, viewed from a designed viewpoint.

An area of each lidar point cloud image 265 has the function of a 3D viewer, and by operating the image area to move the viewpoint from which the image is created, the user can display the lidar point cloud image 265 from any viewpoint. The user can adjust the position and angle of the virtual object of the moving body by manipulating the image 271 of the virtual object appearing on the lidar point cloud image 265. This configuration allows the user to place the virtual object of the moving body in an appropriate state with respect to the 3D point cloud data. Specifically, the user can place the image 271 of the virtual object of the moving body on the road in an appropriate state by adjusting the position and angle of the virtual object while operating the 3D viewer.

The installation check screen 261 has a button 273 for overlaying virtual object, an OK button 274 for expressing OK, and a button 275 for re-positioning settings. By visually checking how the image 271 of the virtual object on the lidar point cloud image 265 is placed, the user confirms that the position of the moving body virtual object has been adjusted to achieve the proper positional relationship between the moving body virtual object and the 3D point cloud data. Then, the user operates the button 273 for overlaying virtual object.

As shown in FIG. 18, when the user operates the button 273 for overlaying virtual object, a sensor image indication section 262 displays, on each camera image, an image 277 of the virtual object corresponding to the image 271 of the virtual object (of the moving body) in the lidar point cloud image 26, which is overlaid on the camera image 263. The same image 278 of the virtual object is also overlaid on each lidar intensity image 264. By visually checking the image 277 of the virtual object is appropriately displayed on the camera images 263, the user checks whether the images 278 of the virtual object of the moving body are properly displayed on the lidar intensity images 264.

In this process, based on the positional relationship between the 3D point cloud data and the virtual object as well as the correspondence between the camera image and the 3D point cloud data acquired in the positioning operation, the traffic flow measurement server 3 overlays the images 277, 278 of the moving body virtual object on the camera images 263 and the lidar intensity images 264, respectively. The camera images 263 and the lidar intensity images 264 include the images 277, 278 of the virtual object of the moving body which have deformed into shapes appropriate for each camera image 263 and each lidar intensity image 264, respectively.

When the user notices that the camera images 263 and/or the lidar intensity images 264 fail to properly display the images 277, 278 of the virtual object of the moving body, respectively, the user can operate to re-adjust the position and angle of the image 271 of the virtual object of the moving body on the lidar point cloud image 265. Next, by operating the button 273 for overlaying virtual object, the user can again check whether the camera images 263 and the lidar intensity images 264 properly display the images 277, 278 of the moving body virtual object are properly, respectively. Then, when the user confirms that the camera images 263 and the lidar intensity images 264 properly display the images 277, 278 of the moving body virtual object, the user operates the OK button 274.

In the present embodiment, the user can update the images 277, 278 of the virtual object on the camera images 263 and the lidar intensity images 264 by re-operating again the button 273 for overlaying virtual object. In other embodiments, the images 277, 278 of the virtual object on the camera images 263 and the lidar intensity images 264 may be updated in real time in response to the user's adjustment of the position and angle of the image 271 of the virtual object on the lidar point cloud image 265.

In this process, the traffic flow measurement server 3 determines, for each camera image 263, whether the image 277 of the virtual object of the moving body does not extend off the camera image 263, and also determines, for each lidar intensity image 264, whether the image 278 of the virtual object of the moving body does not extend off the lidar intensity image 264.

As shown in FIG. 19, when the image 277 of the moving body virtual object extends off a camera image 263, the traffic flow measurement server 3 highlights the display frame of the camera image 263 as a notification action to a user. Specifically, the traffic flow measurement server 3 displays a frame image 281 in a predetermined color (e.g., red) on the display frame of the camera image 263. When the image 278 of the moving body virtual object extends off a lidar intensity image 264, the traffic flow measurement server 3 highlights the display frame of the lidar intensity image 264 in the same way as that of the camera image 263.

In this case, the user can operate again to adjust the position and angle of the image 271 of the moving body virtual object on the lidar point cloud image 265. However, when the user cannot properly re-adjust those on the lidar point cloud image 265, the user operates the button 275 for re-positioning settings. In response, the process returns to the basic adjustment operation in the sensor installation adjustment process, and the screen transitions to the basic adjustment screen 201 (FIG. 8).

In the present embodiment, when an image (image 277 or 278) of the moving body virtual object extends off a sensor image (a camera image 263 or a lidar intensity image 264), the system displays the display frame of the sensor image in a predetermined color (e.g., red) as a highlighting of the sensor image. However, the highlighting of a sensor image is not limited to such a change in the color of the display frame. For example, a highlighting of a sensor image may be blinking of the display frame of the sensor image or changing of the line type (such as dashed line, dotted line) of the display frame of the sensor image.

Thus, in the installation check screen 261, when the virtual object of the moving body is placed on the 3D space containing the 3D point cloud data, the images 277, 278 of the virtual object of the moving body are overlaid on the corresponding sensor images (camera images 263, lidar intensity images 264). This feature allows a user to easily check whether the sensors are set to properly detect the moving body that appears in the measurement area when installation states of the sensors (cameras 1 and lidars 2) are adjusted.

When an image (image 277 or 278) of the moving body virtual object extends off a sensor image (camera image 263 or lidar intensity image 264), the level of warning to be given to a user may be changed based on the degree of part of a moving body image which lies off the sensor image and the priority of the sensor image, in which the traffic flow measurement server 3 detects that a moving body image partially extends off.

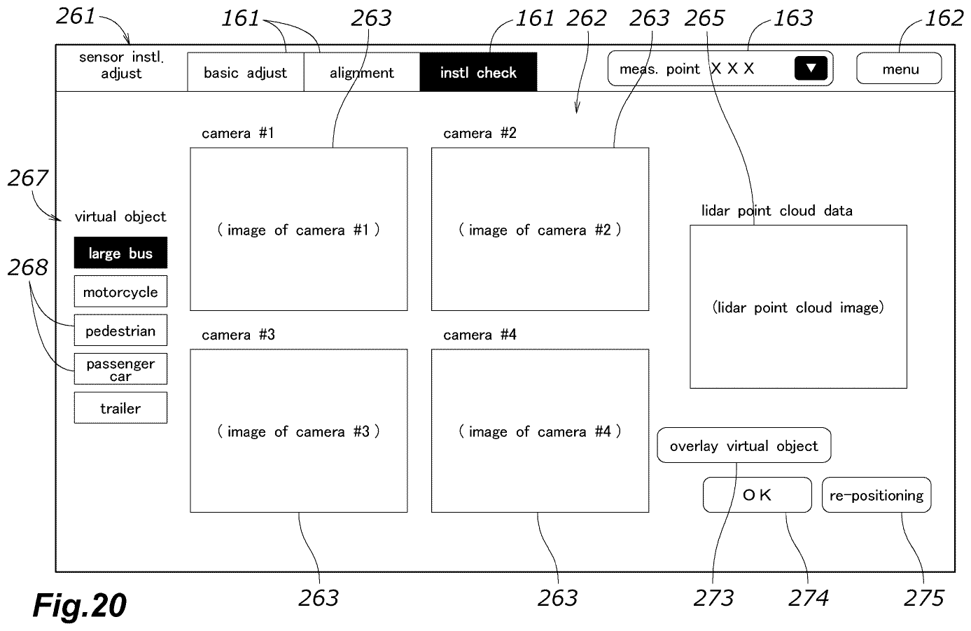

Next, another example of the installation check screen 261 displayed on a user terminal 4 will be described. FIG. 20 is an explanatory diagram showing another example of the installation check screen 261.

In the example shown in FIG. 16, a plurality of sensors (cameras 1 and lidars 2) are installed to detect a moving body of a measurement area across from opposite sides. Specifically, the sensors are installed at two opposite locations across the intersection (measurement area), and the sensors at the two locations detect the same location from different directions.

In the other example shown in FIG. 20, a plurality of sensors (cameras 1 and lidars 2) are installed so that, for each adjoining sensors, their respective measurement areas are adjacent to and partially overlap each other. Specifically, the measurement area includes an intersection with a wide road and its surroundings, and the sensors are installed at four points around the intersection. The sensors located at the four locations detect mainly the center of the intersection, and the respective measurement areas of each adjoining pair of sensors and partially overlap each other. However, since the sensors are installed such that each of the roads connected to the intersection is included in the detection area of a corresponding sensor, the respective detection areas of the sensors at the different locations are largely offset from each other.

In this example, the installation check screen 261 displays four camera images 263 and one lidar point cloud image 265 in the sensor image indication section 262. The four camera images 263 are captured by the four cameras 1 installed at four locations. The one lidar point cloud image 265 is generated from 3D point cloud data generated by integrating four sets of 3D point cloud data acquired by the four lidars 2 installed at the four locations.

In this example, as in the example shown in FIG. 17, when a user selects a moving body virtual object in the virtual object designation section 267, an image 271 of the designated a moving body virtual object appears on the lidar point cloud image 265, and when the user operates the button 273 for overlaying virtual object, the image 277 of the moving body virtual object is overlaid on each of the camera images 263.

In this example, as in the example shown in FIG. 19, when the image 277 of the virtual object of the moving body extends off a camera image 263, the camera image 263 is highlighted. When a missing part of the moving body image is not properly moved in the screen by adjusting the position and angle of the virtual object of the moving body in the lidar point cloud image 265, the user operates the button 275 for re-positioning settings and the process returns to the basic adjustment process in the sensor installation adjustment.

In this way, in this example, the sensors (cameras 1 and lidars 2) at the different locations have respective measurement areas that are adjacent to and partially overlap each other. However, even when the respective detection areas of the sensors (cameras 1 and lidars 2) at the different locations are largely offset from each other, a user is allowed to easily check whether the sensors are set to properly detect the moving body that appears in their measurement areas.

Next, a sensor data record screen 301 displayed on a user terminal 4 will be described. FIG. 21 is an explanatory diagram showing the sensor data record screen 301.

When a user operates the button 103 for traffic flow data generation on the main menu screen 101 (FIG. 5) displayed on the user terminal 4, the screen transitions to the sub-menu screen 121 (FIG. 6(B)), and then, when the user operates the button 122 for sensor data recordation on the sub-menu screen 121, the screen transitions to the sensor data record screen 301, as shown in FIG. 21.

The sensor data record screen 301 includes a sensor image indication section 302. The sensor image indication section 302 displays camera images 303 and lidar intensity images 304. In this example, since the cameras 1 and the lidars 2 are installed at two locations, the sensor image indication section 302 displays the two camera images 303, which are the detection results of the corresponding cameras 1, and the two lidar intensity images 304, which are the detection results of the corresponding lidars 2.

The sensor data record screen 301 includes the measurement point designation section 163, and a user can designate a target measurement point for sensor data recordation by operating the measurement point designation section 163, resulting in that the sensor image indication section 302 displays camera images 303 and lidar intensity images 304 acquired by the cameras and lidars installed at the designated measurement point. A user can select a measurement point by operating the pull-down menu in the measurement point designation section 163. In the case of unregistered measurement points, a user can register a measurement area by entering a name of the new measurement point in the measurement point designation section 163.

The sensor data record screen 301 includes a start recording button 305 and a stop recording button 306. When a user operates the start recording button 305, the traffic flow measurement server 3 starts the sensor data recordation operation. The sensor data recordation operation includes the steps of storing camera images transmitted from the cameras 1 and the lidar point cloud data acquired by the lidars 2 in the storage 12. When the user operates the stop recording button 306, the traffic flow measurement server 3 terminates the sensor data recordation operation for recording traffic flow data.

In some cases, the traffic flow measurement server 3 may be configured such that a user sets a timer so that the sensor data recordation operation is performed until a user-designated measurement time elapses. In other cases, the traffic flow measurement server 3 may be configured such that a user sets a schedule in advance so that the sensor data recordation operation is performed from a user-designated start time to a user-designated end time.

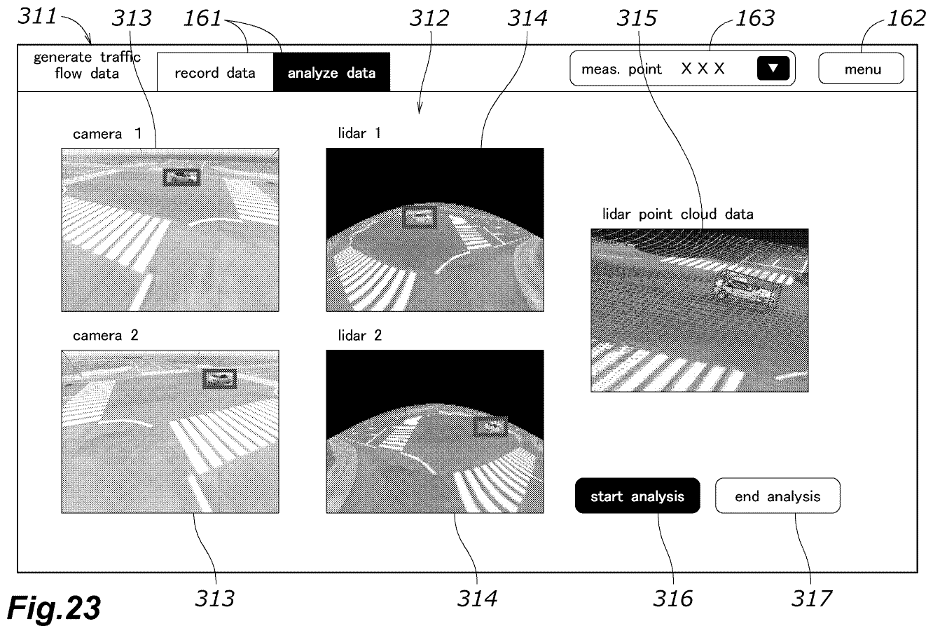

Next, a sensor data analysis screen 311 displayed on a user terminal 4 will be described. FIG. 22 is an explanatory diagram showing the sensor data analysis screen 311 in an initial state. FIG. 23 is an explanatory diagram showing the sensor data analysis screen 311 when the sensor data analysis operation starts.

When a user operates the button 103 for traffic flow data generation on the main menu screen 101 displayed on the user terminal 4 (FIG. 5), the screen transitions to the sub-menu screen 121 (FIG. 6(B)), and then, when the user operates the button 123 for sensor data analysis on the sub-menu screen 121, the screen transitions to the sensor data analysis screen 311, as shown in FIG. 22.

The sensor data analysis screen 311 shown in FIG. 22 includes a sensor image indication section 312. The sensor image indication section 312 displays the camera images 313 and the lidar intensity images 314. In this example, since the cameras 1 and lidars 2 are installed at two locations, the sensor image indication section 322 displays the two camera images 313, which are the detection results of the corresponding cameras 1, and the two lidar intensity images 344, which are the detection results of the corresponding lidars 2.

The sensor data analysis screen 311 includes the measurement point designation section 163, and a user can designate a target measurement point for sensor data analysis by operating the measurement point designation section 163, resulting in that the sensor image indication section 312 displays camera images 313 and lidar intensity images 314 acquired by the cameras and the lidars installed at the designated measurement point.

The sensor data analysis screen 311 includes a start analysis button 316 and a stop analysis button 317. When a user operates the start analysis button 316, the traffic flow measurement server 3 starts the sensor data analysis operation.

The sensor data analysis operation includes the steps of reading camera images and lidar point cloud data stored in the storage 12 to detect moving bodies from camera images and lidar point cloud data, and extracting an event (e.g., traffic accidents) that corresponds to a predetermined scenario from traffic flow data. When the user operates the stop analysis button 317, the traffic flow measurement server 3 terminates the sensor data analysis operation.

As shown in FIG. 23, when the sensor data analysis operation is started, the sensor image indication section 312 displays, in addition to the camera images 313 and the lidar intensity images 314, a lidar point cloud image 315. The camera images 313, the lidar intensity images 314, and the lidar point cloud image 315 may be displayed as video images. The lidar point cloud image 315 is generated from 3D point cloud data generated by integrating 3D point cloud data sets acquired by the lidars 2 located at the two locations.

The traffic flow measurement server 3 displays a tracking frame of a moving body on each camera image 313 in the sensor image indication section 312, the moving body being detected in the camera image 313. The server also displays a tracking frame of a moving body on each lidar intensity image 314, the moving body being detected in the lidar intensity image 314. The server further displays a tracking frame of a moving body on the lidar point cloud image 315, the moving body being detected in the 3D point cloud data.

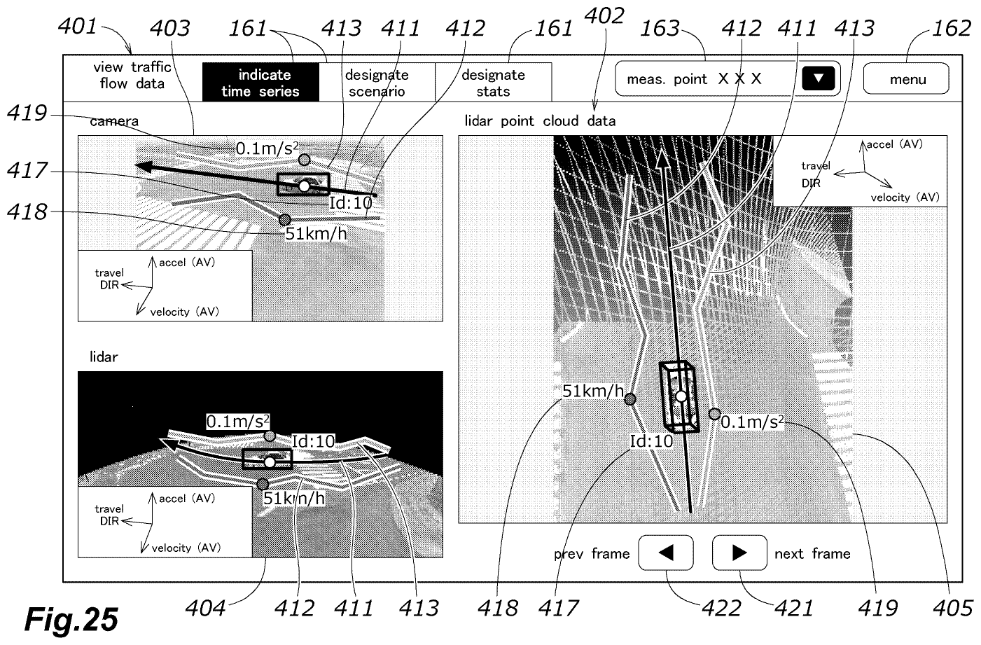

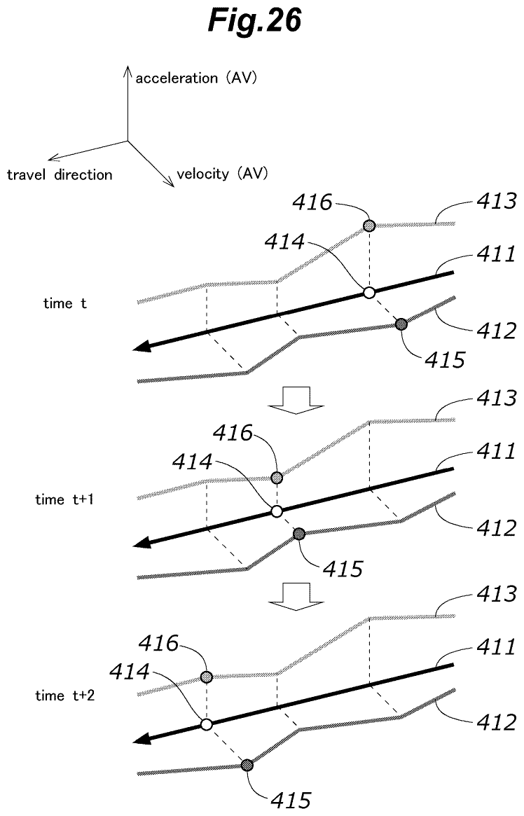

Next, a time series indication screen 401 displayed on a user terminal 4 will be described. FIGS. 24 and 25 are explanatory diagrams showing the time series indication screen 401. FIG. 26 is an explanatory diagram showing a path line 407, a velocity line 408, and an acceleration line 409 at each time displayed on each sensor image in the time series indication screen 401.

When a user operates the button 104 for traffic flow data viewer on the main menu screen 101 displayed on the user terminal 4 (FIG. 5), the screen transitions to the sub-menu screen 131 (FIG. 7(A)), and then, when the user operates the button 132 for time series indication on the sub-menu screen 131, the screen transitions to the time series indication screen 401, as shown in FIG. 24.

The time series indication screen 401 includes a sensor image indication section 402. The sensor image indication section 402 displays camera image 403, a lidar intensity image 404, and a lidar point cloud image 405. An image area of the lidar point cloud image 405 has a function of a 3D viewer, and by operating the image area to move the viewpoint from which the image is created, a user can display the lidar point cloud image 405 from any viewpoint. FIGS. 24 and 25 show an example of changing the viewpoint from which the lidar point cloud image 405 is created.

The sensor image indication section 402 displays the camera image 403, the lidar intensity image 404, and the lidar point cloud image 405, and on each of these images, a path line 411, a velocity line 412, and an acceleration line 413 are overlaid as behavior indicator images, which visualize time-series data representing a behavior (change in a state of moving) of the moving body. The path line 411 (path image) is a visualization of time-series data representing changes in the position of a moving body. The velocity line 412 (velocity image) is a visualization of time-series data representing changes in the velocity of a moving body. The acceleration line 413 (acceleration image) is a visualization of time-series data representing changes in the acceleration of a moving body.

As shown in FIG. 26, a point shown on each path line 411 is a path point 414 representing the position of the moving body at a display time (the time at which a current image is displayed). A point shown on a velocity line 412 is each velocity point 415 representing the velocity of the moving body at a displayed time. A point shown on each acceleration line 413 is an acceleration point 416 representing the acceleration of the moving body at a displayed time. The path point 414, the velocity point 415, and the acceleration point 416 vary with time.

A first coordinate axis is defined to represent the direction of travel, with the origin at a path point 414 representing a position of the moving body. Second and third coordinate axes orthogonal to the first coordinate axis represent the magnitudes (absolute values) of velocity and acceleration, respectively. A magnitude (absolute value) of the velocity is represented by the distance in the direction of the velocity axis from the path point 414 displayed at a display time as an origin point, to a velocity point 415 displayed at the same display time. A magnitude (absolute value) of acceleration is represented by the distance in the acceleration axis direction from the path point 414 at a display time as an origin point, to an acceleration point 416 at the same display time.

Thus, each path line 411 is formed by connecting path points 414 at times, and represents changes in the position of the moving body. Each velocity line 412 is formed by connecting velocity points 415 at times, and represents changes in the velocity of the moving body. Each acceleration line 413 is formed by acceleration points 416 at times, and represents changes in the acceleration of the moving body.

As shown in FIGS. 24 and 25, the sensor image indication section 402 displays, on each sensor image, an ID label 417 (label image), which indicates an ID label including the moving body ID, near the path line 411, a velocity label 418 (label image), which indicates the velocity (absolute value), near the velocity line 412, and an acceleration label 419 (label image), which indicates an acceleration (absolute value), near the acceleration line 413.

In the sensor image indication section 402, a frame displayed on the camera image 403 is a tracking frame of a moving body detected in the camera image 403. A frame displayed on the lidar intensity image 404 is a tracking frame of the moving body detected in the 3D point cloud data. A frame displayed on the lidar point cloud image 405 is a tracking frame of the moving body detected in the 3D point cloud data.

The time series indication screen 401 has a next frame button 421 and a previous frame button 422. When a user operates the next frame button 421, the camera image 403, lidar intensity image 404, and lidar point cloud image 405 switch to their next frames, i.e., the respective images at one frame time later. When the user operates the previous frame button 422, the camera image 403, lidar intensity image 404, and lidar point cloud image 405 switch to their previous frames. i.e., the images at one frame time before.

Methods of showing the path (position), velocity and acceleration of a moving body are not limited to the examples shown in the drawings. For example, velocity and acceleration may be represented by attributes of a path line. Specifically, the color depth and thickness of the path line may represent the velocity and acceleration.

In this way, the time series indication screen 401 displays a visualization of time-series data representing changes in the states of a moving body. Specifically, the time series indication screen 401 displays the sensor images (the camera image 403, the lidar intensity image 404, and the lidar point cloud image 405), on each of which lines are overlaid; that is, a path line 411, a velocity line 412, and an acceleration line 413 are overlaid as behavior indicator images, which visualize time-series data representing the position, velocity, and acceleration. This configuration allows a user to intuitively grasp the changes in the state of a moving body (position, velocity, and acceleration). In some cases, the time series indication screen may be configured such that a user operates a section screen (not shown) to select any one or more images from the different behavior indicator images (path line 411, velocity line 412, and acceleration line 413) and different label images (ID label 417, velocity label 418, and acceleration label 419), and the one or more selected images are displayed.

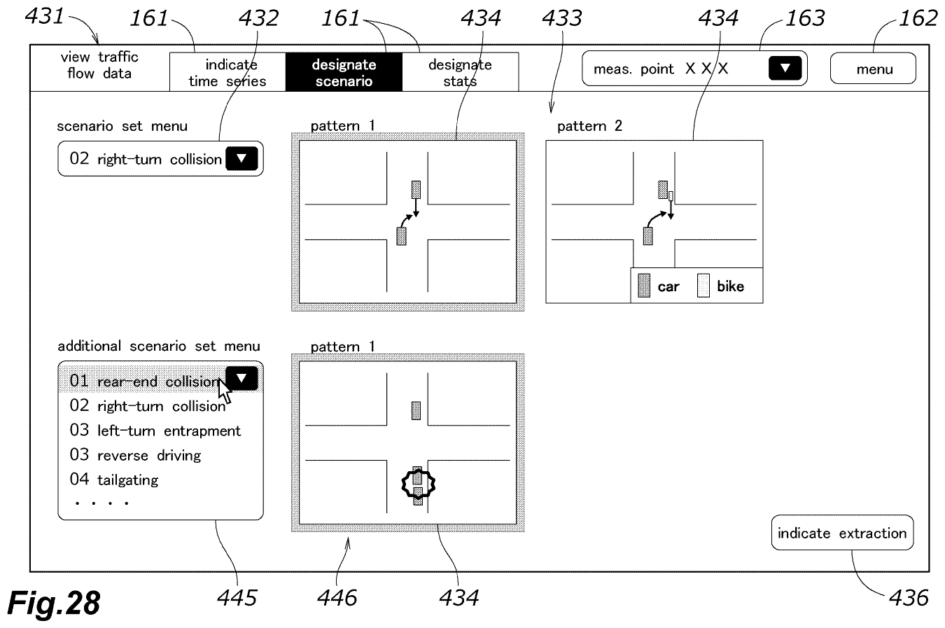

Next, a scenario designation screen 431 displayed on a user terminal 4 will be described. FIG. 27 is an explanatory diagram showing the scenario designation screen 431. FIG. 28 is an explanatory diagram showing the scenario designation screen 431 for entry of an additional condition for extraction.

When a user operates the button 104 for traffic flow data viewer on the main menu screen 101 displayed on the user terminal 4 (FIG. 5), the screen transitions to the sub-menu screen 131 for traffic flow data viewer (FIG. 7(A)), and then, when the user operates the button 133 for scenario designation on the sub-menu screen 131, the screen transitions to the scenario designation screen 431, as shown in FIG. 27.

The scenario designation screen 431 has an extraction condition selection section 432 and an overview indication section 433. A user can select a scenario (event type) by operating the pull-down menu in the extraction condition selection section 432. In this example, the user can select a scenario such as rear-end collision, right-turn collision, left-turn entrapment, reverse driving, and tailgating. When the user selects a scenario, the screen displays an overview diagram(s) 434 for the selected scenario in the overview indication section 433. The overview diagram(s) 434 shows one or more situations corresponding to the selected scenario.

When a selected scenario corresponds to a plurality of situation patterns, the screen displays overview diagrams 434 for respective patterns. In the example shown in FIG. 27, a first pattern is a collision between a right-turning vehicle and a vehicle proceeding straight ahead, and a second pattern is a collision between a right-turning vehicle and a straight-ahead motorcycle. A user can select a pattern by operating the overview diagrams 434.

The scenario designation screen 431 has an extraction button 436. When the user selects a scenario as an extraction condition in the extraction condition selection section 432 and then operates the extraction button 436, the traffic flow measurement server 3 performs the extraction operation and the screen transitions to the designated event viewer screen 471 (FIG. 30), which displays the result of extraction. In the extraction operation, the traffic flow measurement server 3 extracts an event corresponding to the scenario selected by the user, from events (such as traffic accident) detected in the traffic flow analysis operation (event detection).

In the scenario designation screen 431, when a user selects a scenario as an extraction condition, the extraction condition selection section 432 displays an additional condition designation section 441 (dialog box). The additional condition designation section 441 has a Yes button 442 and a No button 443. When the user operates the Yes button 442, the screen transitions to the scenario designation screen 431 for entry of an additional condition for extraction, as shown in FIG. 28.

The scenario designation screen 431 for entry of an additional condition for extraction shown in FIG. 28 displays the extraction condition selection section 432 and the overview indication section 433 that are initially displayed, and further displays the extraction condition selection section 445 and the overview indication section 446 for additional extraction condition. This configuration allows a user to narrow down event situations to be extracted by using a combination of scenarios.

In this way, the scenario designation screen 431 allows a user to designate one or more scenarios (event types) of the user's interest, and then extract an event (such as a traffic accident) that corresponds to the designated scenario.

Examples of scenarios may include, but are not limited to, violations of traffic rules or dangerous driving such as reverse driving, and tailgating, in addition to traffic accidents such as rear-end collisions, right-turn collisions, and left-turn roll-ins.

Next, a statistical data designation screen 461 displayed on a user terminal 4 will be described. FIG. 29 is an explanatory diagram showing the statistical data designation screen 461.

When a user operates the button 104 for traffic flow data viewer on the main menu screen 101 displayed on the user terminal 4 (FIG. 5), the screen transitions to the sub-menu screen 131 (FIG. 7(A)), and then, when the user operates the button 134 for statistical data designation on the sub-menu screen 131, the screen transitions to the statistical data designation screen 461, as shown in FIG. 29.

The statistical data designation screen 461 has a first statistical data display section 462 (graph display section) and a second statistical data display section 463 (cross-table table display section). The first statistical data display section 462 displays, as statistical information, the numbers of events (frequencies of occurrence) corresponding to respective scenarios in a bar graph. The second statistical data display section 463 displays, as statistical information, the numbers of events (frequencies of occurrence) extracted based on each combination of scenarios in a cross-table.

A user can select one scenario by operating one corresponding bar in the bar chart shown in the first statistical data display section 462. In addition, a user can select a combination of scenarios by operating one cell in the cross-table in the second statistical data display section.

The statistical data designation screen 461 also has an extraction button 464. When the user selects a scenario shown in the first statistical data display section 462 and then operates the extraction button 464, the traffic flow measurement server 3 extracts an event(s) corresponding to the selected scenario, and the screen transitions to the designated event viewer screen 471 (FIG. 30), which displays the result of extraction. When the user selects a combination of scenarios in the second statistical data display section 463 and then operates the extraction button 464, the traffic flow measurement server 3 extracts an event(s) corresponding to the selected scenario combination, and the screen transitions to the designated event viewer screen 471 (FIG. 30), which displays the result of extraction.

In this way, after checking the numbers (frequencies of occurrence) of an event corresponding to each scenario in statistical information (graph and cross-table) shown on the statistical data designation screen 461, a user can select a scenario(s) which the user wishes to view from the statistical information, thereby causing the server to an event (e.g., traffic accident) that corresponds to the scenario(s).

In the example shown in FIGS. 27 and 28, the scenario designation screen 431 includes the extraction condition selection section 432 and the overview indication section 433, and a user can select a scenario (event type) by operating the pull-down menu. Similarly, in the statistical data designation screen 461 as shown in FIG. 29, the statistical data display sections 462, 463 may only display types of statistical information (graph and cross-table) that have been narrowed by a scenario selected by a user

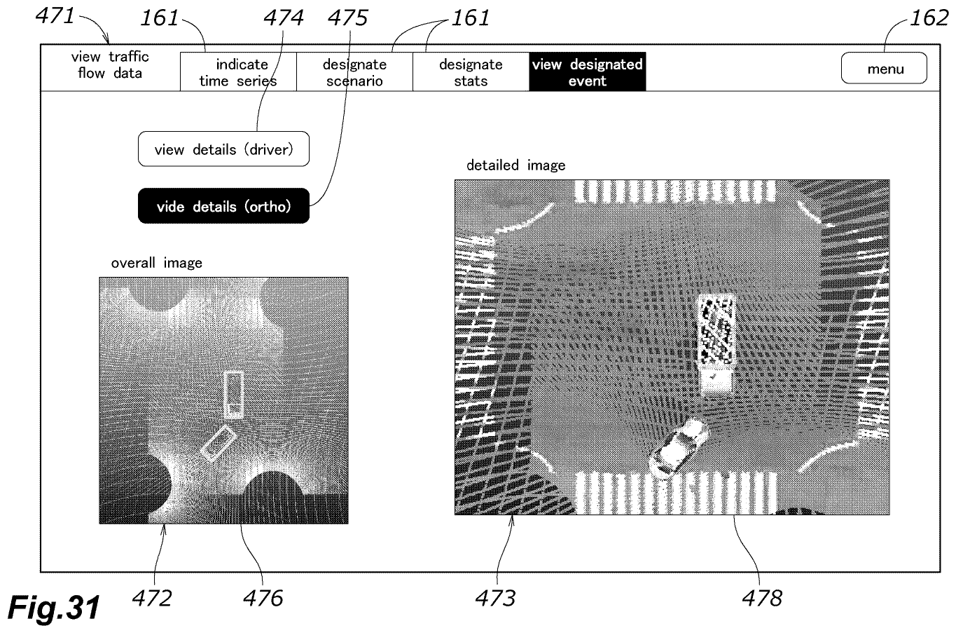

Next, a designated event viewer screen 471 displayed on a user terminal 4 will be described. FIGS. 30 and 31 are explanatory diagrams showing the designated event viewer screen 471.

When a user operates the scenario designation screen 431 (FIGS. 27 and 28) or the statistical data designation screen 461 (FIG. 29) shown in a user terminal 4 to designate a scenario, thereby enter instructions to display the extracted information, the screen transitions to the designated event viewer screen 471.

The designated event viewer screen 471 includes an overall image display section 472, a detailed image display section 473, a first detailed image button 474, and a second detailed image button 475.

The overall image display section 472 displays an overall image, which is a lidar point cloud image 476 showing an overall situation of an event. The lidar point cloud image 476 is generated from 3D point cloud data by the lidars 2, with the viewpoint above the measurement area.

The overall image display section 472 highlights a moving body associated with an event which corresponds to a scenario, designed by a user by operating the scenario designation screen 431 (FIGS. 27 and 28) and the statistical data designation screen 461 (FIG. 29). In the example shown in FIG. 30, the overall image display section 472 displays tracking frame images for two vehicles associated with a traffic accident (right-turn collision) as an event. The detailed image display section 473 displays detailed images 477, 478, which are enlarged to allow a user to grasp details of the event situation corresponding to the scenario designated by the user.

When a user operates the first detailed image button 474, the designated event viewer screen displays a lidar point cloud image 477 with a driver's viewpoint as a detailed image from a first viewpoint. The driver is a person driving a vehicle as a moving body associated with the designated event. When a user operates the second detailed image button 475, the designated event viewer screen displays a lidar point cloud image 478 (ortho-image) as a detailed image with a second viewpoint set above the measurement area.

In this way, after designating a scenario (event type) of a user's interest by operating the scenario designation screen 431 (FIGS. 27 and 28) or the statistical data designation screen 461 (FIG. 29), the user can a view sensor image (lidar point cloud image 477 or 478) corresponding to the designated scenario and displayed in the designated event viewer screen 471. This configuration allows the user to restrict scenarios into a specific one and check details of an event situation corresponding to the specific scenario when the event occurred.

In this example, a user can select either the lidar point cloud image 476 with the viewpoint of the driver or the lidar point cloud image 477 with the viewpoint above the measurement area. In other cases, a display frame of the lidar point cloud image may have a function of a 3D viewer, which allows a user to display the lidar point cloud image with any viewpoint.

In the present embodiment, lidar point cloud images 476, 477 with any viewpoint can be generated from 3D point cloud data acquired by the lidars 2. In other embodiments, a point cloud data image with any viewpoint, may be generated from camera images acquired by a plurality of cameras 1 by using multi-view stereo technology.

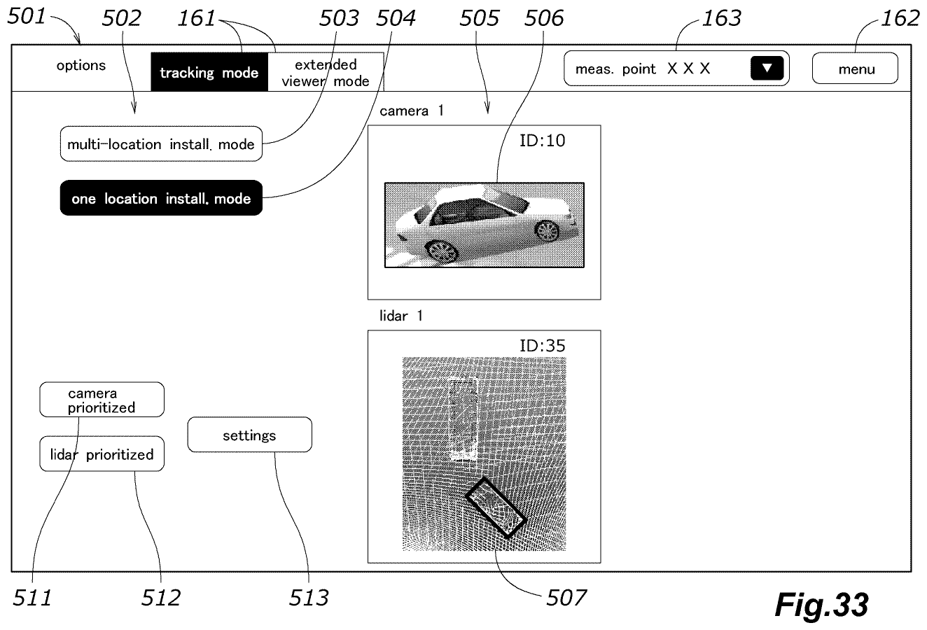

Next, a tracking mode screen 501 displayed on a user terminal 4 will be described. FIG. 32 is an explanatory diagram showing the tracking mode screen 501 for multi-location installation mode. FIG. 33 is an explanatory diagram showing the tracking mode screen 501 for one location installation mode.

When a user operates the button 105 for options on the main menu screen 101 displayed on the user terminal 4 (FIG. 5), the screen transitions to the sub-menu screen 141 (FIG. 7(B)), and then, when the user operates the button 142 for tracking mode on the sub-menu screen 141, the screen transitions to the tracking mode screen 501, as shown in FIG. 32.

The tracking mode screen 501 includes a mode selection section 502. The mode selection section 502 has a button 503 for multi-location installation mode 503 and a button 504 for one location installation mode 504. When a user operates the button 503 for multi-location installation mode 503, the screen transitions to the tracking mode screen 501 for multi-location installation mode shown in FIG. 32. When the user operates the button 504 for one location installation mode 504, the screen transitions to the tracking mode screen 501 for one location installation mode shown in FIG. 33. The multi-location installation mode is selected when cameras 1 and lidars 2 are installed at a plurality of locations for a common measurement area. The one-location installation mode is selected when a camera 1 and a lidar 2 are installed at a single location.

The tracking mode screen 501 includes a moving body image display section 505. The moving body image display section 505 displays an image 506 of the moving body detected in the camera images and an image 507 of the moving body detected in the 3D point cloud data. The images 506 of the moving body detected in each of the camera images is an image area including the moving body extracted from the camera image. The moving body image 507 detected in the 3D point cloud data is an image area including the moving body extracted from the lidar point cloud image generated from the 3D point cloud data. When a plurality of moving bodies are shown in the moving body images 507, a frame image may be shown so as to surround a target one of the moving bodies.

The tracking mode screen 501 for multi-location installation mode shown in FIG. 32 displays an image 506 of the moving body detected in the camera image acquired by each camera 1. In this example, two cameras 1 are installed, and thus two images 506 of a moving body are displayed in the tracking mode screen 501. Furthermore, a plurality of lidars 2 are installed at different locations, and thus a plurality of sets of 3D point cloud data acquired by the plurality of lidars 2 are integrated into one set of integrated 3D point cloud data, and thus the moving body detected in the integrated 3D point cloud data is displayed.

The tracking mode screen 501 for one location installation mode shown in FIG. 33, displays a single moving body image 506 detected in the camera image and another single moving body image 507 detected in the 3D point cloud data.

The moving body image display section 505 displays a moving body ID assigned to a moving body when the moving body is detected in a camera image and another moving body ID assigned to the moving body when the moving body is detected in the 3D point cloud data. Since the detection of a moving body and the assignment of a moving body ID are performed on an individual basis, a first moving body ID of a moving body detected in a camera image acquired by a camera 1 is different from a second moving body ID of the same moving body detected in 3D point cloud data acquired by a lidar.

The tracking mode screen 501 includes a camera prioritize button 511, a lidar prioritize button 512, and a settings button 513. When a user operates the camera prioritize button 511, the traffic flow measurement server 3 performs reassignment of the moving body ID; that is, reassigns a moving body ID to a moving body detected in a camera image in priority to the moving body ID detected in the 3D point cloud data. When a user operates the lidar prioritize button 512, the traffic flow measurement server 3 reassigns a moving body ID to a moving body detected in 3D point cloud data in priority to a moving body ID of one detected in a camera image. Which is more useful and should be prioritized, camera images or lidar point cloud data, is determined depending on the detection scene such as a situation of a measurement area or a weather condition. For example, a user may designate a sensor that is expected to have higher accuracy in the detection of a moving body than the other sensor.

After the moving body IDs are reassigned, the moving body image display section 505 updates moving body IDs of a moving body detected in the camera image and the lidar point cloud image, so as to display the same moving body ID for the same moving body. When the user confirms that the moving body ID has been properly reassigned, the user operates the settings button 513 to determine the moving body ID.

In this way, when the moving body ID is reassigned to a moving body detected in each of the detection results (camera image and 3D point cloud data) from different sensors (camera(s) 1 and lidar(s) 2) such that a common moving body ID is assigned to the same moving body, the tracking mode screen 501 allows a user to select a prioritized sensor.

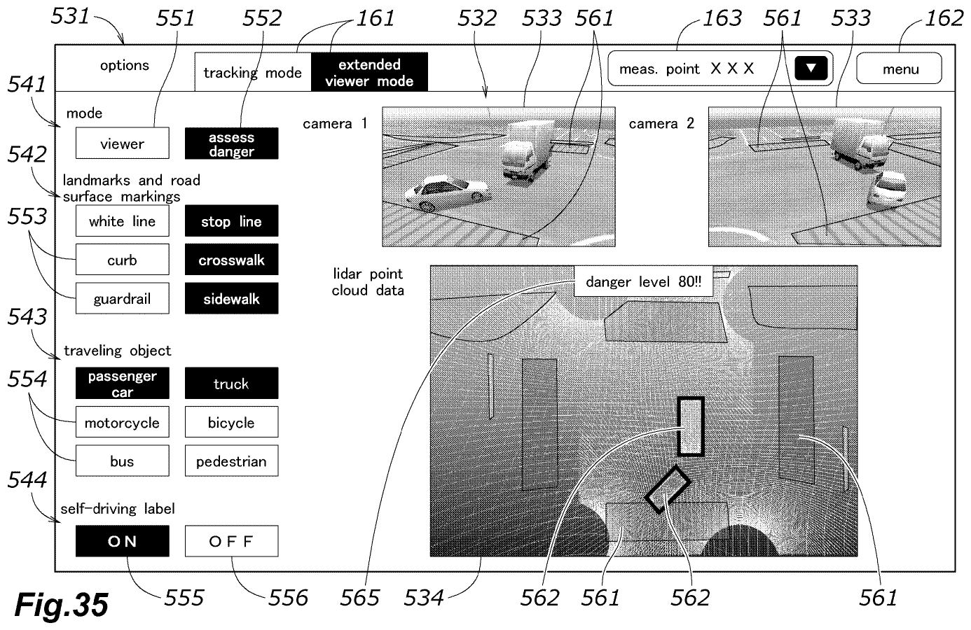

Next, an extended viewer mode screen 531 displayed on a user terminal 4 will be described. FIG. 34 is an explanatory diagram showing the extended viewer mode screen 531 in a viewer mode. FIG. 35 is an explanatory diagram showing the extended viewer mode screen 531 in a danger assessment mode.

When a user operates the button 104 for traffic flow data viewer on the main menu screen 101 displayed on the user terminal 4 (FIG. 5), the screen transitions to the sub-menu screen 141 (FIG. 7(B)), and then, when the user operates the button 143 for extended viewer mode on the sub-menu screen 141, the screen transitions to the extended viewer mode screen 531, as shown in FIG. 34.

The extended viewer mode screen 531 includes a sensor image indication section 532. The sensor image indication section 532 displays camera images 533 and a point cloud image 534. In this example, since the cameras 1 are installed at two locations, the sensor image indication section 532 displays the two camera images 533, which are the detection results of the corresponding cameras 1. Two sets of 3D point cloud data acquired by the lidars 2 installed at two locations are integrated into a set of 3D point cloud data, and the lidar point cloud image 534 is generated from the set of 3D point cloud data, with the viewpoint above the measurement area.

In addition, the extended viewer mode screen 531 includes a mode designation section 541, a road component designation section 542, a traveling object designation section 543, and a self-driving designation section 544.

The mode designation section 541 has a viewer button 551 and a danger assessment button 552. When a user operates the viewer button 551, the screen transitions to the extended viewer mode screen 531 for viewer mode shown in FIG. 34. When a user operates the danger assessment button 552, the screen transitions to the extended viewer mode screen 531 for viewer mode shown in FIG. 35.

The road component designation section 542 has buttons 553 for selecting road components (landmarks and road surface markings). In this example, a user can operate the buttons 553 to select one or more from a group consisting of white lines, stop lines, curbs, crosswalks, guardrails, and sidewalks as road components. Each of the selected road components is highlighted in the camera images 533 and the lidar point cloud image 534. Specifically, an area image 561 (supplemental image) shown in a predetermined color or pattern is transparently overlaid on the area of a target road component in each of the camera images 533 and the lidar point cloud image 534. In this example, the areas of stop lines, crosswalks, and sidewalks are highlighted. The area images 561 of road components are shown in colors and patterns set for each type of road component. For example, the area images 561 of pedestrian crosswalks are shown in blue, and the area images 561 of sidewalks are shown in red. This configuration allows a user to easily identify the type of each road component. It should be noted that a user can select a plurality of road components.

The traveling object designation section 543 has a button 554 for selecting a traveling object (moving body). In this example, by operating the button 554, a user can select one or more from a group consisting of a passenger car, a truck, a motorcycle, a bicycle, a bus, and a pedestrian as a traveling object(s). A selected traveling object is highlighted on the lidar point cloud image 534. Specifically, an area image 562 (supplemental image) shown in a predetermined color or pattern is transparently overlaid on the area of a target traveling object in the lidar point cloud image 534. The area image 562 of the traveling object is shown in a color or pattern set for each type of traveling object. For example, the area image 562 of a passenger car is shown in light blue, and the area image 562 of a truck is shown in yellow. This configuration allows a user to easily identify the type of traveling object. It should be noted that a user can select a plurality of traveling objects.

The self-driving designation section 544 has buttons 555 and 556 for selecting self-driving vehicle or non-self-droving vehicle. When the user operates the ON button 555, a self-driving vehicle is highlighted on the lidar point cloud image 534, and a self-driving label 563 (supplemental image) with the word “self-driving” is displayed. When the user operations the OFF button 556, the self-driving vehicle is not highlighted on the lidar point cloud image 534.

In the extended viewer mode screen 531, when a user selects road components on the lidar point cloud image 534, more specifically, when a user manipulates the area image 561 of a road component overlaid on the lidar point cloud image 534 or the area image 562 of a traveling object, the extended viewer mode screen 531 displays a relative position label 564 (supplemental image) with information about the positional relationship between the traveling object and the road component. In the example shown in FIG. 34, when a user selects a truck and a crosswalk on the lidar point cloud image 534, the lidar point cloud image displays a relative position label 564 which includes the distance between the truck and the crosswalk.

The extended viewer mode screen for danger assessment shown in FIG. 35 includes a danger level display section 565. The danger level display section 565 displays the danger level concerning a traffic environment at a target location. When the danger level is displayed, the traffic flow measurement server 3 determines the danger level of the traffic environment at the target location based on information about the traffic environment at the target location, i.e., based on the positional relationship between the moving body (traveling object) and the road component.

In this way, in the extended viewer mode screen 531, the areas of a moving body and a road component designated by a user are highlighted in the lidar point cloud image 534, which allows the user to easily grasp the relative positional relationship between the moving body and the road component. Since the extended viewer mode screen 531 displays information about the positional relationship between the moving body and the road component (such as distance) and the danger level information about a traffic environment at the target location, a user is allowed to easily recognize the danger of the moving body. Thus, the features allow the user to consider necessary measures to improve the road structure, such as installing guardrails at a point with a higher danger level, thereby reducing the number of traffic accidents.

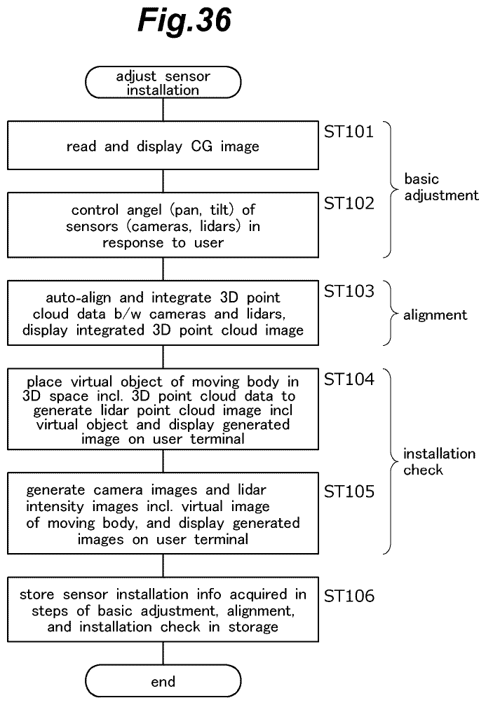

Next, a procedure of operations for sensor installation adjustment performed by the traffic flow measurement server 3 will be described. FIG. 36 is a flowchart showing the procedure of operations for sensor installation adjustment. In this process, a user selects the sub-menu items on the sub-menu screen for sensor installation adjustment 111 (see FIG. 6(A)) displayed on a user terminal 4, thereby causing the traffic flow measurement server 3 to perform operations of basic adjustment, alignment, and installation check described below. Prior to this process, an installation worker needs to install sensors (a camera(s) 1 and a lidar(s) 2) at predetermined points. As a result, the positions of the sensors are determined so that the orientations (angles of view) of the sensors can be adjusted during the operations of sensor installation adjustment.

First, the process proceeds to the step of basic adjustment, where the traffic flow measurement server 3 reads out CG image file in response to a user's operation on the basic adjustment screen 201 (FIGS. 8 to 11) displayed on the user terminal 4, and transmits the CG image file to the user terminal 4 where the CG image is displayed on the user terminal 4 (ST101).

Next, the traffic flow measurement server 3 changes the angles (pan and tilt) of the sensors (camera)s 1 and lidars 2) according to the user's operation on the basic adjustment screen 201 (FIGS. 8 to 11) displayed on the user terminal 4 (ST102). Then, the sensor images (camera image, lidar intensity image) from the sensors are transmitted to the user terminal 4 where those sensor images are displayed.

Next, the process proceeds the step of alignment, and the traffic flow measurement server 3 performs an adjustment operation to adjust the sensors to correct the misalignment between image data from the cameras 1 and 3D point cloud data acquired by the lidars 2, both the sensors being installed at different locations. After the adjustment, the traffic flow measurement server 3 transmits the lidar point cloud image generated from the integrated 3D point cloud data to the user terminal 4 where the lidar point cloud image is displayed (ST103).

In ST103, when automatic adjustment fails to properly correct the misalignment of the 3D point cloud data acquired by a plurality of lidars 2, the traffic flow measurement server 3 allows for the user's manual adjustment to correct the misalignment of the 3D point cloud data acquired by the plurality of lidars 2.

Next, the process proceeds to the step of installation check, and in response to the user's operations on the installation check screen 261 (FIGS. 16 to 20) displayed on the user terminal 4, the traffic flow measurement server 3 places a virtual object of a moving body in a 3D space containing 3D point cloud data to thereby generate lidar point cloud images including the virtual object of the moving body. Then, the traffic flow measurement server 3 transmits the lidar point cloud images including the virtual object of the moving body to the user terminal 4 where the lidar point cloud images are displayed (ST104).

Next, in response to the user's operation on the installation check screen 261 (FIGS. 16 to 20) displayed on the user terminal 4, the traffic flow measurement server 3 generates camera images including the moving body virtual object and lidar intensity images. Then, the traffic flow measurement server 3 transmits the camera images and the lidar intensity images including the virtual object of the moving body to the user terminal 4, where the camera images and the lidar intensity images are displayed (ST105).

In ST105, when the virtual object of the moving body is not properly displayed in the camera images and the lidar intensity images, the traffic flow measurement server 3 repeats the operations of ST104 and ST105 to adjust the display state of the virtual object of the moving body.

Next, the traffic flow measurement server 3 stores sensor installation information acquired in the prior steps including the basic adjustment, the alignment, and installation check in the storage 12 (ST106). The sensor installation information includes information on the angles of the sensors (cameras 1 and lidars 2), information on the positional relationship between the camera images and sets of the 3D point cloud data, and information on the positional relationship between the sets of 3D point cloud data acquired by the plurality of lidars 2.

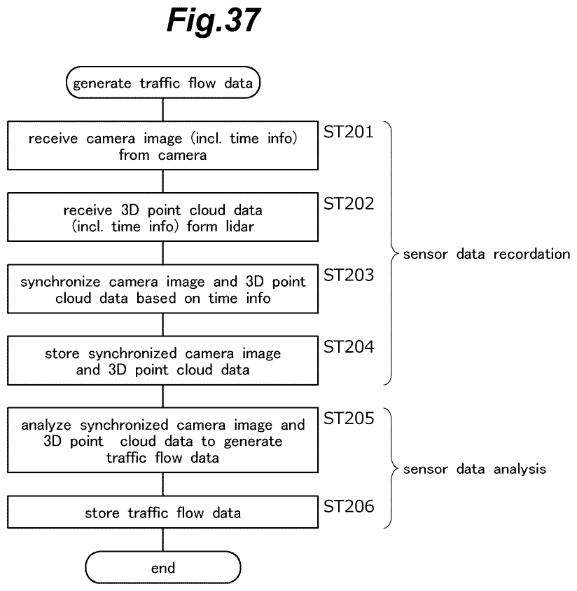

Next, a procedure of operation for traffic flow data generation performed by the traffic flow measurement server 3 will be described. FIG. 37 is a flow diagram showing the procedure for traffic flow data generation. This entire process as described later includes a process of sensor data recordation and that of sensor data analysis, each process starting when a user selects a corresponding one of the buttons in the sub-menu screen 121 for traffic flow data generation (FIG. 6(B)) displayed on a user terminal 4.

First, the process proceeds to the step of data recordation, and the traffic flow measurement server 3 receives camera images from a camera(s) 1 (ST201). The traffic flow measurement server 3 also receives 3D point cloud data sets from a lidar(s) 2 (ST202).

Next, based on time information added to the camera images received from the camera 1 and another time information added to the 3D point cloud data received from the lidar 2, the traffic flow measurement server 3 synchronizes the camera images and the 3D point cloud data (data synchronization operations) (ST203). The camera 1 and the lidar 2 receive respective time information from satellite signals. When either the camera or the lidar does not have the capability of receiving satellite signals, the time information for synchronization may be acquired via a local network.

Next, the traffic flow measurement server 3 stores the synchronized camera images and 3D point cloud data in the storage 12 (ST204).

Next, the process proceeds to the process of sensor data analysis, in which the traffic flow measurement server 3 performs the sensor data analysis operation for analyzing camera images and 3D point cloud data to generate traffic flow data (ST205). In the sensor data analysis operation, the traffic flow measurement server 3 performs operations of detecting moving bodies and road components from the camera images and the lidar point cloud data.

Next, the traffic flow measurement server 3 stores the traffic flow data generated in the sensor data analysis operation in the storage 12 (ST206). The traffic flow data includes a time stamp (year, month, day, hour, minute, second), a path ID (information identifying each moving body), relative coordinates (position information), and other data.

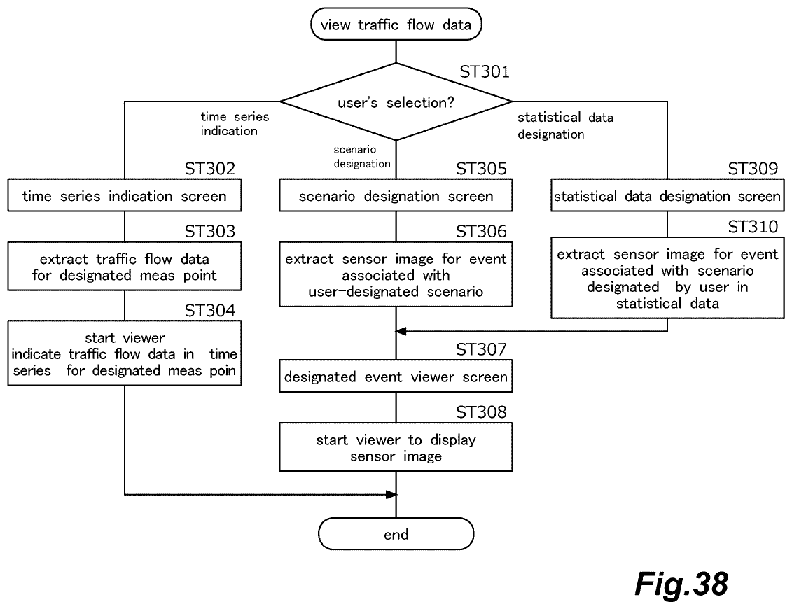

Next, a procedure of operations for traffic data viewer performed by the traffic flow measurement server 3 will be described. FIG. 38 is a flowchart showing the procedure of operations for traffic data viewer.

First, after a user selects one of the types of operations shown in the sub-menu screen for traffic flow data viewer 131 (FIG. 7(A)) displayed on a user terminal 4, the traffic flow measurement server 3 determines the operation type selected by the user (ST301).

When the user selects time series indication (“time series indication” in ST301), the traffic flow measurement server 3 causes the screen on the user terminal 4 to transition to the time series indication screen 401 (FIG. 24) (ST302). Then, when the user designates a measurement point (measurement area) on the time series indication screen 401, the traffic flow measurement server 3 extracts traffic flow data associated with the designated measurement point (ST303). Next, the traffic flow measurement server 3 starts a viewer in the time series indication screen 401 to display the traffic flow data in a time series (ST304). The time series indication screen 401 indicates, as traffic flow data, changes in the moving body path, velocity, and acceleration in each of the sensor images (camera images, the lidar intensity image, and the lidar point cloud image).

When the user selects scenario designation (“scenario designation” in ST301), the traffic flow measurement server 3 controls the user terminal 4 so that the screen transitions to the time series indication screen 401 (FIG. 24) (ST302). When the user selects an option of scenario designation (“scenario designation” in ST301), the traffic flow measurement server 3 controls the user terminal 4 so that the screen transitions to the scenario designation screen 431 (FIG. 27) (ST305). Then, when the user directly designates a scenario on the scenario designation screen 431, the traffic flow measurement server 3 extracts the sensor images for an event corresponding to the designated scenario (ST306).

Next, the traffic flow measurement server 3 controls the user terminal 4 so that the screen transitions to the designated event viewer screen 471 (FIG. 30) (ST307). Then, the traffic flow measurement server 3 starts a viewer in the designated event viewer screen 471 to display the sensor images on the designated event viewer screen 471 (ST308). The designated event viewer screen 471 indicates, as a sensor image, a lidar point cloud image associated with the event corresponding to the designated scenario.

When a user selects statistical data designation (“statistical data designation” in ST301), the traffic flow measurement server 3 controls the user terminal 4 so that the screen transitions to the statistical data designation screen 461 (FIG. 29) (ST309). When the user designates a scenario in the statistical data shown on the statistical data designation screen 461, the traffic flow measurement server 3 extracts the sensor images associated with an event corresponding to the designated scenario (ST310). Next, the traffic flow measurement server 3 performs the operations of the steps ST307 and ST308.

While specific embodiments of the present disclosure are described herein for illustrative purposes, the present disclosure is not limited to those specific embodiments. It will be understood that various changes, substitutions, additions, and omissions may be made to elements of the embodiments without departing from the scope of the invention. In addition, elements and features of the different embodiments may be combined with each other to yield an embodiment of the present disclosure.

### INDUSTRIAL APPLICABILITY

A traffic flow measurement system and a traffic flow measurement method according to the present disclosure have an effect of enabling a user to easily check whether or not a sensor is set to properly detect a moving body that appears in a measurement area after adjustment of an installation state of the sensor, and are useful as a traffic flow measurement system and a traffic flow measurement method for measuring a traffic flow at a target location using sensors such as cameras and lidars.

### Glossary

1 camera (first sensor)
2 lidar (second sensor)
3 traffic flow measurement server (server device)
4 user terminal (terminal device)
5 management terminal

1. A traffic flow measurement system comprising:
a first sensor configured to acquire a two-dimensional detection result of a measurement area of a traffic flow;
a second sensor configured to acquire a three-dimensional detection result of the measurement area;
a server device connected to the first and second sensors and configured to acquire sensor images based on the detection results of the first and second sensors, and perform a traffic flow analysis operation; and
a terminal device which is connected to the server device via a network and displays the sensor images and a result of the traffic flow analysis operation,
wherein, in response to a user's operation on the terminal device, the server device places a virtual object of a moving body in a three-dimensional space including the three-dimensional detection result acquired by the second sensor, and
wherein, based on a positional relationship between the three-dimensional detection result of the measurement area and the virtual object, the server device generates an installation check screen in which the virtual object of the moving body is overlaid on the sensor image which is the two-dimensional detection result acquired by the first sensor, and transmits the installation check screen to the terminal device.

2. The traffic flow measurement system as claimed in claim 1, wherein, based on a positional relationship between three-dimensional information on the measurement area and the virtual object, the server device generates an installation check screen in which the virtual object of the moving body is overlaid on a sensor image which is generated from the three-dimensional detection result acquired by the second sensor.

3. The traffic flow measurement system as claimed in claim 1, wherein the first sensor is a camera that acquires a captured image as the two-dimensional detection result, and the second sensor is a lidar that acquires three-dimensional point cloud data as the three-dimensional detection result.

4. The traffic flow measurement system as claimed in claim 1, wherein, in response to the user's operation to select a type of the moving body, the server device places a virtual object of the selected type of a moving body in the three-dimensional space.

5. The traffic flow measurement system as claimed in claim 1, wherein, when the virtual object of the moving object overlaid on a sensor image includes a part that is extending off and missing from the sensor image, the server device highlights the sensor image.

6. The traffic flow measurement system as claimed in claim 5, wherein a method of highlighting the sensor image is at least one of blinking, changing a color, and changing a line type of a display frame of the sensor image.

7. A traffic flow measurement method performed by a traffic flow measurement system comprising:
a first sensor configured to acquire a two-dimensional detection result of a measurement area of a traffic flow;
a second sensor configured to acquire a three-dimensional detection result of the measurement area;
a server device connected to the first and second sensors and configured to acquire sensor images based on the detection results of the first and second sensors, and perform a traffic flow analysis operation; and
a terminal device which is connected to the server device via a network and displays the sensor images and a result of the traffic flow analysis operation,
wherein the traffic flow measurement method comprises performing operations by the server device, the operations comprising:
in response to a user's operation on the terminal device, placing a virtual object of a moving body in a three-dimensional space including the three-dimensional detection result acquired by the second sensor, and
based on a positional relationship between the three-dimensional detection result of the measurement area and the virtual object, generating an installation check screen in which by overlaying the virtual object of the moving body is overlaid on the sensor image which is the two-dimensional detection result acquired by the first sensor, and
transmitting the installation check screen to the terminal device.
